(19) United States
(12) Patent Application Publication
(10) Pub. No.: US 2025/0112528 A1
(43) Pub. Date: Apr. 3, 2025

(54) PRINTED CIRCUIT BOARD STATOR AXIAL FIELD ROTARY ENERGY DEVICE WITH FERROMAGNETIC CORE

(71) Applicant: INFINITUM ELECTRIC, INC., Round Rock, TX (US)

(72) Inventors: Bahareh Anvari, Round Rock, TX (US); Richard Lee, Austin, TX (US); Randal A. Lee, Austin, TX (US); Paulo Guedes-Pinto, Round Rock, TX (US)

(73) Assignee: INFINITUM ELECTRIC, INC., Round Rock, TX (US)

(21) Appl. No.: 18/897,284

(22) Filed: Sep. 26, 2024

Related U.S. Application Data
(60) Provisional application No. 63/541,071, filed on Sep. 28, 2023.

(51) Int. Cl. H02K 11/33; H02K 1/12; H02K 1/2793; H02K 3/26; H02K 5/20; H02K 9/19; H02K 9/22; H02K 21/24

(52) U.S. Cl. CPC H02K 11/33; H02K 1/12; H02K 1/2793; H02K 3/26; H02K 5/203; H02K 9/19; H02K 21/24; H02K 9/22; H02K 2203/03; H02K 2211/03

(57) ABSTRACT

An axial field rotary energy device includes housing sections, each with a ferromagnetic core having teeth. A printed circuit board (PCB) stator assembly is mechanically and thermally coupled to each housing section and has stator windows through which the teeth protrude. An external circumferential channel directs a flow of a liquid coolant. A first lobe is aligned with an adjacent first lobe on an adjacent housing section. The first lobes form a manifold to distribute the liquid coolant to the housing sections. A second lobe is aligned with an adjacent second lobe on the adjacent housing section. The second lobes contain conductors for electrical connections of the PCB stator assemblies. The device also has an air gap between each facing pair of the ferromagnetic cores. A rotor with a rotor disk is axially positioned in a center of each respective air gap and has magnets.

### CROSS-REFERENCE TO RELATED APPLICATIONS

This patent application claims priority to and the benefit of U.S. Prov. Pat. App. No. 63/541,071, filed Sep. 28, 2023, which is incorporated herein by reference in its entirety.

### BACKGROUND OF THE INVENTION

### Field of the Invention

The present invention relates in general to an axial field rotary energy device and, in particular, to motors and generators having one or more printed circuit board (PCB) stators and one or more ferromagnetic cores.

### Description of the Prior Art

Some axial field rotary energy devices, such as motors or generators, use printed circuit board (PCB) stator structures. Examples of such devices are described in U.S. Pat. Nos. 10,141,803, 10,135,310, 10,340,760, 10,141,804, 10,680,479 and 10,186,922, each of which is incorporated herein by reference. These axial field rotary energy devices with PCB stator structures do not have a ferromagnetic stator core, and typically have two or more rotor disks to establish a magnetic circuit. The rotor disks have permanent magnets that establish the magnetic field that interacts with the magnetic field produced by the PCB stator to generate torque (for motors) or induce electromotive forces (EMF) on the PCB stator (for generators). There is a large magnetic air gap (on the order of millimeters) between opposing magnets on the rotor disks. To achieve a flux density on the order of hundreds of mT (milli Tesla) in the air gap, these axial field rotary energy devices typically require a larger magnet mass than similarly rated axial field rotary energy devices with ferromagnetic stator cores. Therefore, it is desirable to explore other axial field rotary device configurations that can operate with reduced magnet mass. One method of enhancing the magnetic flux density in those axial field rotary energy devices, without increasing the magnet mass, is to add ferromagnetic materials to the PCB stator structure.

Embodiments of axial field electric machines with ferromagnetic stator cores have been proposed in the past. US Patent Publications 2022/0286001, 2017/0025927 and 2019/0288584 teach axial field electric machines with one stator assembly and two rotors. The stator assembly is axially positioned between the two rotors and it has independent ferromagnetic cores. Each ferromagnetic core has its own coil of wound copper. These axial field rotary energy devices require a complex mechanical structure to support each individual ferromagnetic core and corresponding coil to form a stator assembly. In addition, the ferromagnetic cores and corresponding coils must be coupled to a complex cooling system, as neither the coils nor the ferromagnetic cores are directly mounted to a heat sink or similar heat removal device. Given the complexity of these devices, improved axial field rotary energy devices continue to be of interest.

### SUMMARY OF THE INVENTION

Embodiments of axial field rotary energy devices comprising printed circuit board (PCB) stator assemblies with ferromagnetic cores are disclosed. For example, an axial field rotary energy device can include a housing with at least two sections axially aligned with each other, and a rotor coaxial with the housing comprising a shaft, an axis of rotation, and, at least one rotor disk having a magnet. Each housing section can comprise a stator assembly coaxial with the rotor. The stator assembly can include a printed circuit board (PCB) having a plurality of conductive layers laminated together with layers of an insulating material, and the wiring required to electrically connect the stator assembly. Each conductive layer of the stator assembly can have a plurality of coils that can carry electrical current when connected to an external voltage source. In some embodiments, the stator assembly can comprise a single monolithic PCB. In other embodiments, the stator assembly can comprise a plurality of PCB segments electrically interconnected to each other to provide a continuous path for an electric current. The stator assembly can be mechanically coupled to a respective housing section, such that the stator assembly reacts to the torque produced by the axial field rotary energy device. The stator assembly also can be thermally coupled to the housing section, so the heat generated by the circulations of current in the PCB stator can be transferred to the housing section by conduction. Each housing section, in turn, can have features to facilitate the heat removal from the respective stator assembly, such as fins or cooling plates, for example, enabling air or liquid cooling, respectively. In addition, each housing section can comprise a ferromagnetic core that is coaxial with the rotor and mechanically and thermally coupled to the housing section. The ferromagnetic core also is coupled to the respective stator assembly to provide a path for the magnetic flux produced by the rotor magnets that interacts with the magnetic flux produced by the stator coils.

### BRIEF DESCRIPTION OF THE DRAWINGS

So that the manner in which the features and advantages of the embodiments are attained and can be understood in more detail, a more particular description can be had by reference to the embodiments that are illustrated in the appended drawings. However, the drawings illustrate only some embodiments and are not to be considered limiting in scope since there can be other equally effective embodiments.

It shall be noted that some of the details and/or features shown in the drawings may not be drawn to scale for clarity purposes.

FIG. 1A is an isometric view of an embodiment of an axial field rotary energy device.

FIG. 1B is a sectional side view of the axial field rotary energy device shown in FIG. 1A.

FIG. 1C is an exploded isometric view of the axial field rotary energy device shown in FIG. 1A.

FIG. 2 is an isometric view of an embodiment of a housing section of an axial field rotary energy device showing a PCB stator assembly and ferromagnetic core.

FIG. 3A is an isometric view of an embodiment of a ferromagnetic core.

FIG. 3B is an isometric view of an embodiment of a segment of a ferromagnetic core.

FIG. 3C is an isometric view of an embodiment of a segmented ferromagnetic core and a PCB stator segment.

FIG. 4A is an isometric view of an embodiment of a housing section of an axial field rotary energy device showing PCB stator segment mounting details.

FIG. 4B is an enlarged isometric, partially sectioned view of a portion of the housing section shown in FIG. 4A.

FIG. 5 is a top view of a portion of an embodiment of the housing section of an axial field rotary energy device showing PCB stator segment details.

FIG. 6A is an isometric view of an embodiment of a PCB stator segment.

FIG. 6B is a schematic diagram showing an embodiment of electrical connections in a PCB stator segment.

FIG. 6C is a sectional side view of the PCB stator segment shown in FIG. 6A, taken along the line 60-6C in FIG. 6A.

FIGS. 6D-6F are sectional side views of different embodiments of PCB stator segments.

FIG. 6G is a top view of an embodiment of a PCB stator segment with four windows.

FIG. 7A is an isometric view of an embodiment of a rotor for an axial field rotary energy device.

FIG. 7B is an enlarged top view of a portion of the rotor shown in FIG. 7A.

FIG. 7C is a top view of an embodiment of an assembly sequence of magnets in the rotor shown in FIG. 7A.

FIG. 7D is an isometric view of an alternate embodiment of a rotor for an axial field rotary energy device.

FIG. 7E is an enlarged top view of a portion of the rotor shown in FIG. 7D.

FIG. 7F is an enlarged sectional side view of the rotor shown in FIG. 7E, taken along the line 7F-7F in FIG. 7E.

FIG. 7G is an isometric view of an alternate embodiment of a rotor for an axial field rotary energy device.

FIG. 7H is an enlarged top view of a portion of the rotor shown in FIG. 7G.

FIG. 7J is an isometric view of an embodiment of a magnet of the rotor shown in FIG. 7G.

FIG. 7K is a sectional side view of the rotor shown in FIG. 7H, taken along the line 7K-7K in FIG. 7H.

FIG. 7L is an isometric view of an alternate embodiment of a rotor for an axial field rotary energy device.

FIG. 7M is an enlarged sectional side view of the rotor of FIG. 7L, taken along the line 7M-7M.

FIG. 7N is an isometric view of an alternate embodiment of a rotor for an axial field rotary energy device.

FIG. 7P is an enlarged sectional side view of the rotor of FIG. 7N, taken along the line 7P-7P.

FIG. 7Q is an enlarged top view of a portion of the rotor shown in FIG. 7N.

FIG. 7R is an isometric view of an alternate embodiment of a rotor for an axial field rotary energy device.

FIG. 7S is an enlarged sectional view of the rotor of FIG. 7R, taken along the line 7S-7S.

FIG. 7T is an enlarged isometric view of an embodiment of a magnet for the rotor of FIG. 7R.

FIG. 8A is an isometric view on an embodiment of an axial field rotary energy device capable of liquid cooling.

FIG. 8B is a sectional side view of the axial field rotary energy device shown in FIG. 8A.

FIG. 8C is an exploded isometric view of the axial field rotary energy device shown in FIG. 8A.

FIG. 9A is a top view of an embodiment of a cooling plate for an axial field rotary energy device.

FIG. 9B is a top view of another embodiment of a cooling plate for an axial field rotary energy device.

FIG. 10A is an isometric view of an axial field rotary energy device with more than one rotor.

FIG. 10B is a sectional side view of the axial field rotary energy device shown in FIG. 10A.

FIG. 10C is an exploded isometric view of the axial field rotary energy device shown in FIG. 10A.

FIG. 10D is an enlarged isometric view of a portion of the axial field rotary energy device shown in FIG. 10C.

FIG. 10E is an enlarged isometric view of another portion of the axial field rotary energy device shown in FIG. 10C.

### DETAILED DESCRIPTION

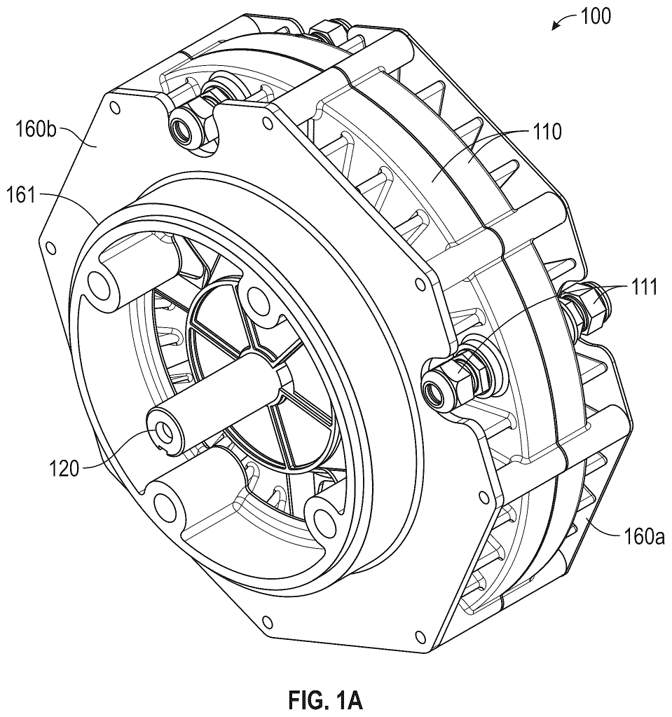

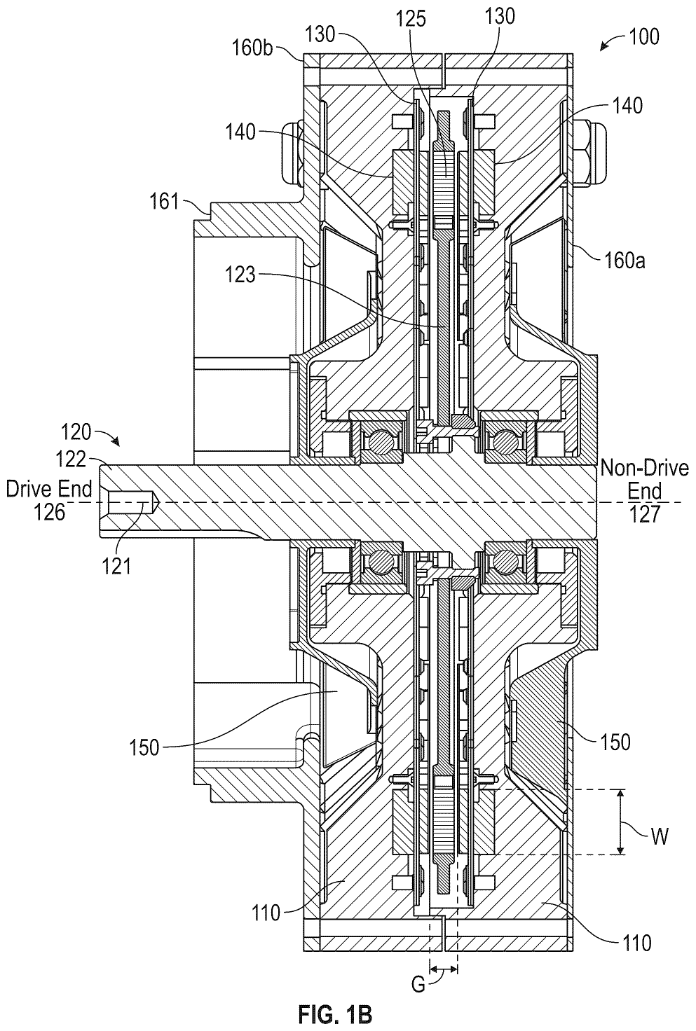

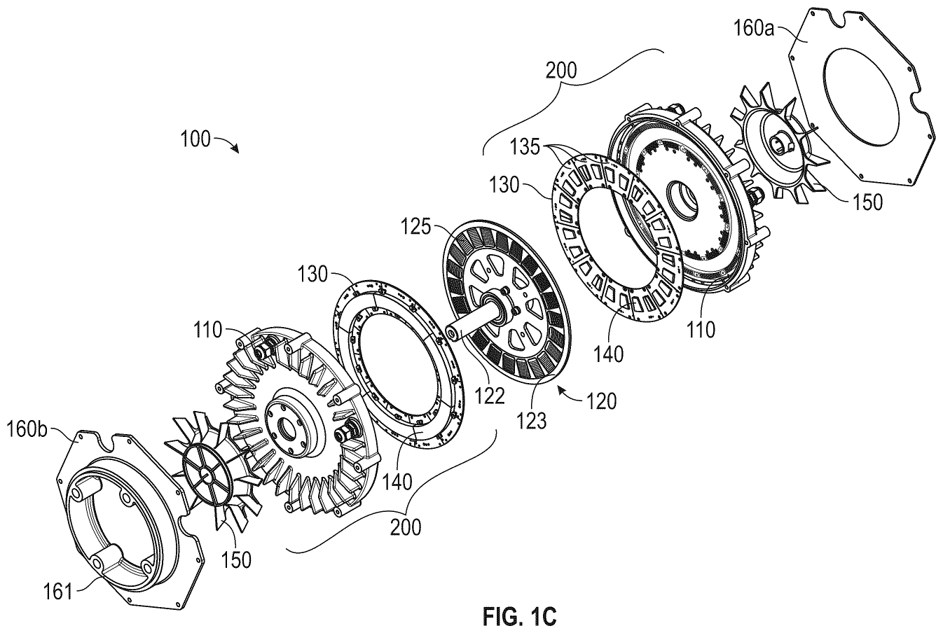

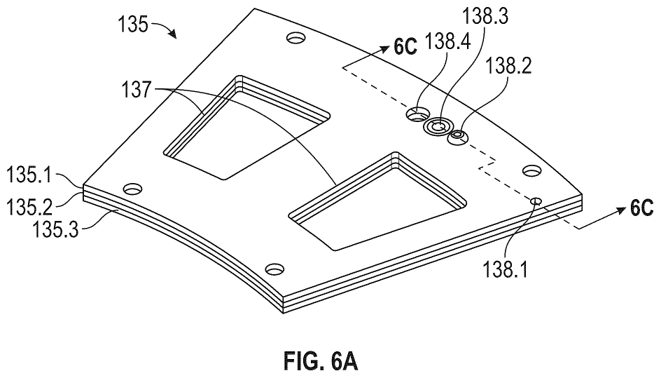

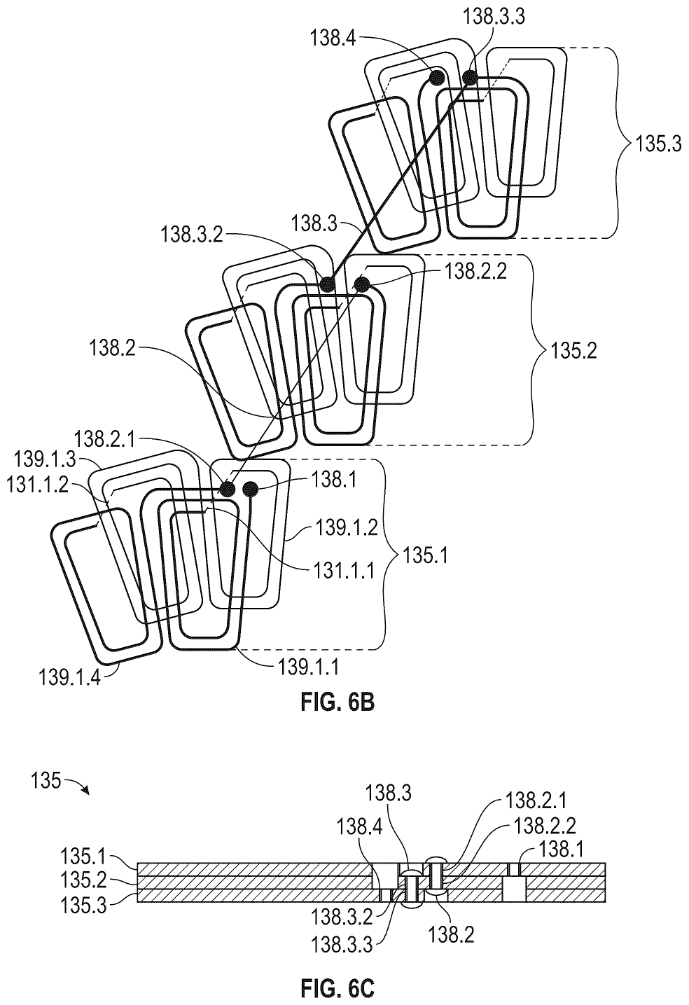

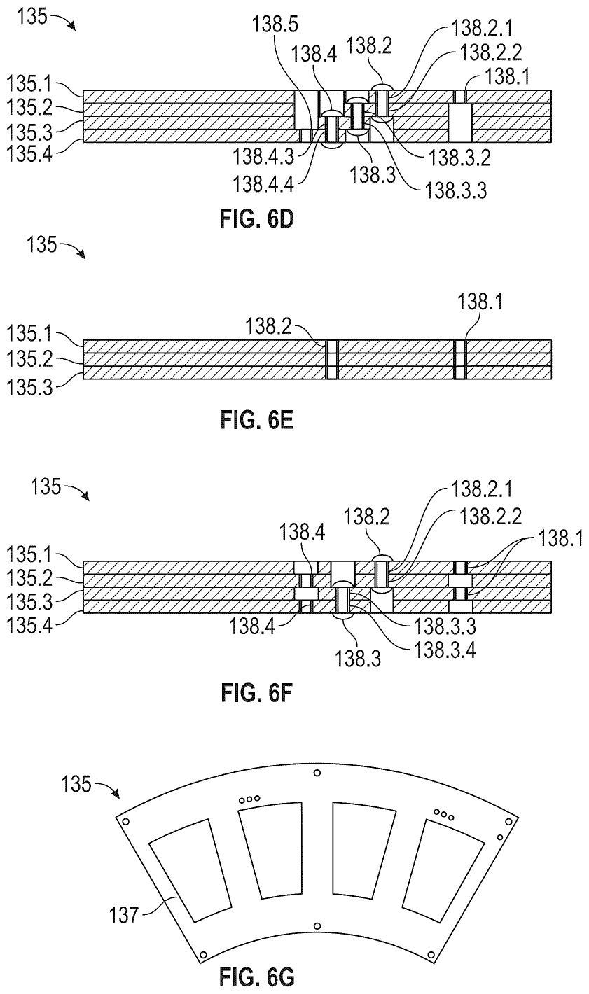

Some axial field rotary energy devices, such as the device 100 shown in FIGS. 1A, 1B and 1C, can have a housing comprised of two housing sections 110 axially aligned and coupled to each other. A rotor 120 can be coaxial with the housing and can rotate about an axis of rotation 121 (FIG. 1B). The rotor can comprise a shaft 122 coaxial with the axis of rotation 121, and a rotor disk 123 attached to the shaft 122. The rotor disk 123 can carry magnets 125 that are evenly spaced circumferentially around the rotor disk 123. Both the rotor disk 123 and magnets 125 are coaxial with the axis of rotation 121. The axial field rotary energy device 100 can have a drive end 126, where the shaft 122 extends in the axial direction to enable coupling the axial field rotary energy device 100 to a load, such as when the device 100 is a motor. Alternatively, the device 100 can be a generator and coupled to a prime mover. The opposite end of the axial field rotary energy device 100 is referred to as a non-drive end (127 in FIG. 1B), which also can have a shaft extension where an external fan 150 (FIG. 1C) can be coupled to it, for example. The axial field rotary energy device 100 can have the rotor disk 123 positioned between two stator assemblies 130 coaxial with the rotor 120 relative to the axis of rotation 121. Each stator assembly 130 can be mechanically coupled to a corresponding housing section 110 and can comprise a printed circuit board (PCB). Hereinafter, the stator assembly 130 is referred to as a “PCB stator assembly 130”. The PCB stator assembly 130 can have a plurality of conductive layers of copper foil laminated together with layers of an insulating material, such as FR4 epoxy-glass laminate, for example, so the conductive layers are not exposed except at the points where electrical connections are desired (see, e.g., terminal 138.1 in FIG. 6A). Each copper foil layer can be etched to form a plurality of coils that can carry electrical currents when connected to an external voltage source. Each PCB stator assembly 130 can comprise a plurality of PCB stator segments 135 (FIG. 1C) that are discrete and mechanically and electrically coupled together, and to an external polyphase power supply such as a 3-phase power supply, for example. Although each PCB stator assembly 130 can comprise a single monolithic PCB, in some embodiments it can be advantageous to have a PCB stator assembly comprising the PCB stator segments 135. The segmented PCB construction can provide better utilization and less waste of the constituent materials (FR-4 copper clad laminate and FR-4 prepreg, for example) used in the manufacturing of the PCBs. While each of the PCB stator segments 135 can be assigned to one electrical phase, an electrical phase can be connected to a plurality of PCB stator segments 135, which can be connected to each other in series, parallel of a combination of both.

The axial field rotary energy device 100 can further comprise ferromagnetic cores 140 that are mechanically coupled to each respective housing section 110 (FIGS. 1B and 1C) and coaxial with the rotor 120. The housing sections 110 are configured in such a way that, when they are coupled together, an axial gap “G” (FIG. 1B) can exist between the opposing ferromagnetic cores 140. The gap “G” can accommodate the rotor disk 123 and its magnets 125 leaving an air gap between each face of the magnets 125 and the corresponding ferromagnetic core 140. For operation of the axial field rotary energy device 100, the air gaps can be made substantially the same on both sides of the magnets 125 with a typical air gap width in a range between about 0.5 mm to about 1.5 mm, for example. The ferromagnetic cores 140 can be aligned in the radial direction with the magnets 125, and the radial width “W” (FIG. 1B) of the ferromagnetic cores 140 can be substantially the same as the radial width of the magnets 125 to enhance the portion of the magnetic flux produced by the magnets 125 that is linked with the ferromagnetic cores 140.

The ferromagnetic cores 140 can be thermally coupled to each respective housing section 110 (FIGS. 1B and 1C), so the heat generated by hysteretic and eddy current losses in the ferromagnetic cores 140 can be conducted to the housing and removed by convection, or by any other suitable heat removal method. In some embodiments, a thermal interface material can be applied between the ferromagnetic cores 140 and the respective housing section 110 to enhance the heat transfer. The housing sections 110 can have external radial fins which can be cooled by the flow of cooling air produced by external fans 150 rotatably coupled to the rotor 120. The air flow can be guided over the surface of the housing sections 110 by the shrouds 160a and 160b. The shroud 160b on the drive end side 126 of the axial field rotary energy device 100, can have a mounting flange 161 that enables mounting the axial field rotary energy device 100 to a support bracket, or directly to an apparatus coupled to the axial field rotary energy device 100. Some embodiments of the axial field rotary energy device 100 can have mounting feet or some other mounting scheme instead of the mounting flange 161. A housing section 110, and corresponding PCB stator assembly 130 and ferromagnetic core form a housing assembly 200 (FIG. 1C).

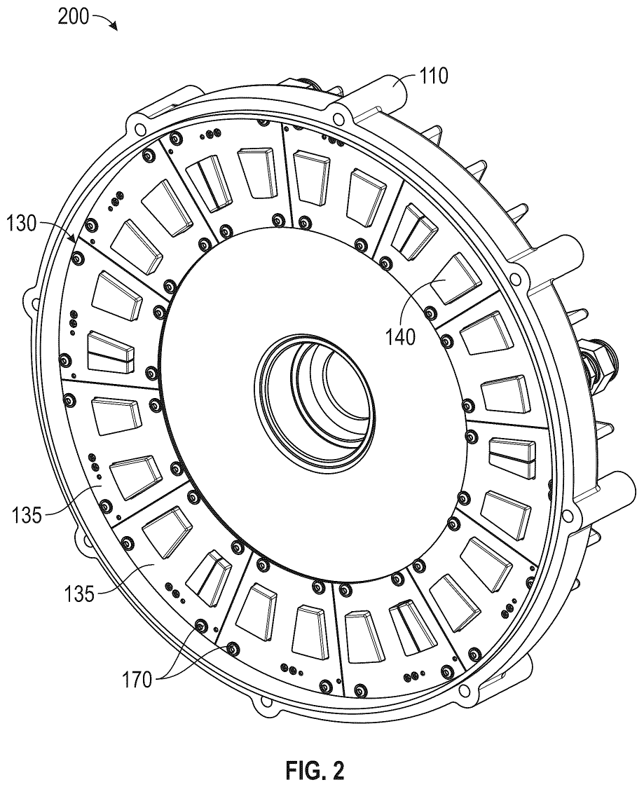

FIG. 2 shows a view of a housing assembly 200 of the axial field rotary energy device 100 comprising a housing section 110 with its respective PCB stator assembly 130 having a plurality of PCB stator segments 135 (only two segments are identified in FIG. 2 for clarity), and its respective ferromagnetic core 140. The housing section 110 can be made of a metal alloy such cast aluminum, cast iron, cast steel or can be machined out of a metal alloy such as 6061 aluminum, A36 steel or other structural metal alloys, for example.

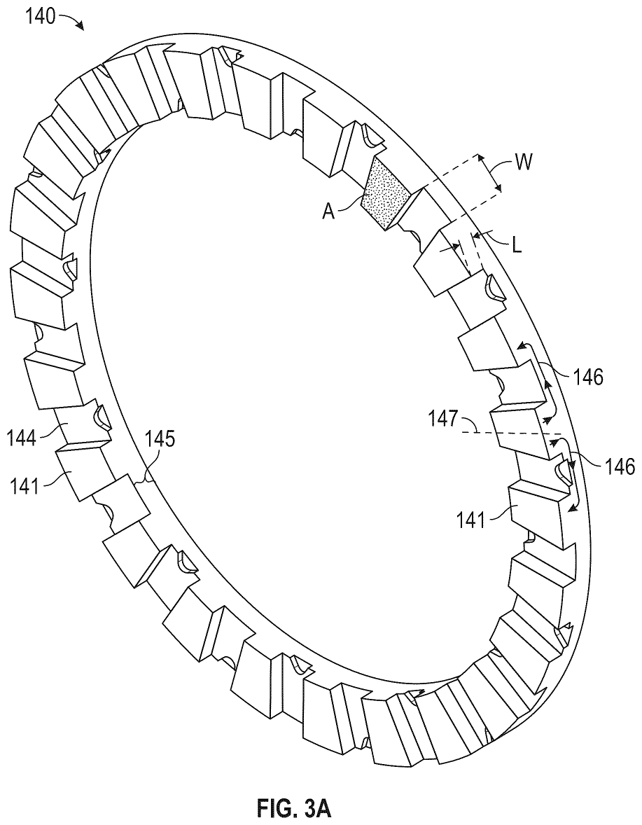

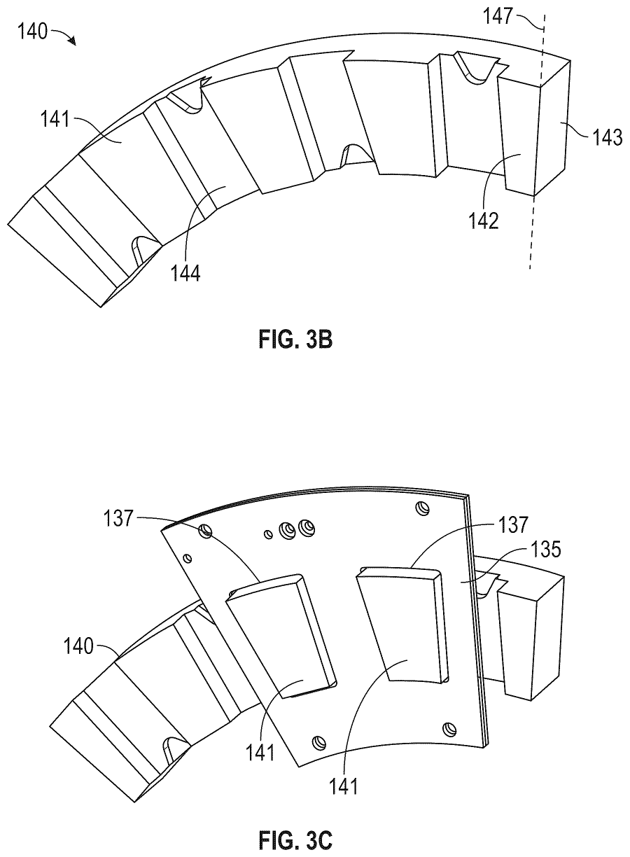

FIGS. 3A and 3B depict examples of ferromagnetic cores 140. FIG. 3A shows a monolithic ferromagnetic core 140 that can have a toroidal shape, called a yoke 145 or back iron. The yoke 145 can have a uniform cross-section throughout the entire circumference of the ferromagnetic core 140. From the yoke 145, a plurality of teeth 141 can protrude in an axial direction. Each of the teeth 141 can have substantially the same area “A” (shown shaded) and the same length “L”, and the teeth 141 can be uniformly spaced around the circumference of the yoke 145. The gaps between the teeth 141 are called slots and, consistently with the teeth 141, the slots 144 can have uniform depth “L” (same as length “L” of teeth 141) and width “W”. The ferromagnetic cores 140 can be made of a soft magnetic material, such as a soft magnetic composite (SMC), or can be laminated having a continuous wound strip of a soft ferromagnetic alloy, such as silicon steel, for example.

One function of the ferromagnetic core 140 is to carry the magnetic flux generated by the magnets 125 and by the currents that circulate in the PCB stator assembly 130 during the operation of the axial field rotary energy device 100. In general, the magnetic flux will enter the ferromagnetic core 140 through a first tooth 141 in a substantially axial direction (see arrow path 146 in FIG. 3A), then branch out circumferentially in two opposing directions, and exit the ferromagnetic core 140 through teeth 141 adjacent to the first tooth 141. The magnetic flux at the radial centerline 147 of the tooth 141 is substantially axial with a negligible circumferential component.

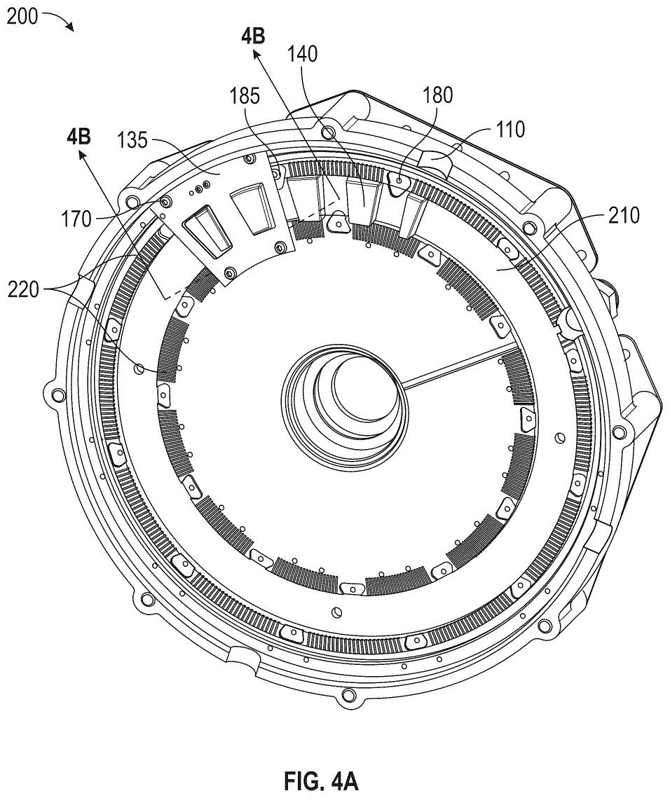

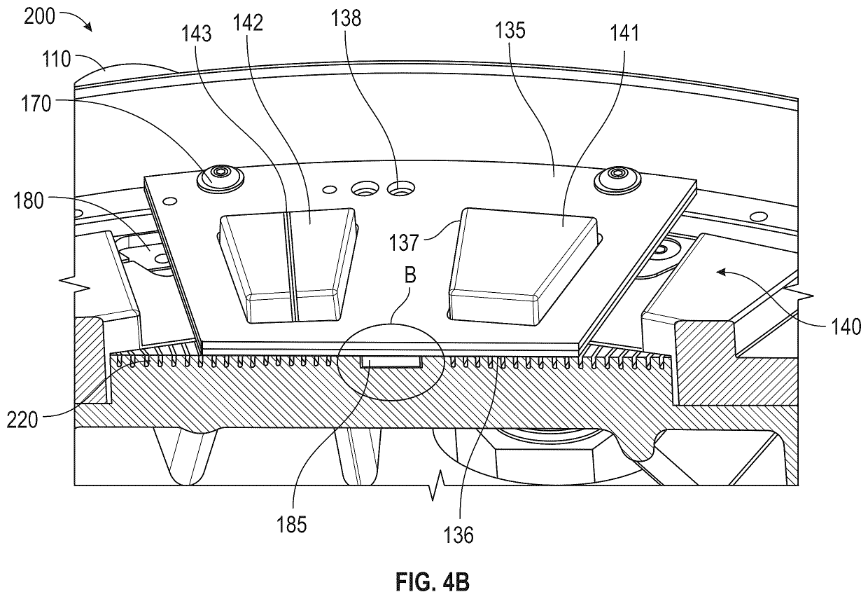

In some embodiments, the ferromagnetic core 140 can be segmented as shown in FIGS. 3B and 4B. Those embodiments can have splits 143 between adjacent segments. The splits 143 can increase the magnetic reluctance of the ferromagnetic core 140, which is undesirable. To mitigate this effect, the split 143 between adjacent segments of the ferromagnetic core 140, can be oriented in a substantially radial direction bisecting a selected tooth 142 at about the radial centerline 147 of the selected tooth 142. This arrangement helps to reduce the magnetic reluctance.

The teeth 141 of the ferromagnetic core 140 can align axially with the PCB stator segments 135 (FIG. 3C), which can have openings 137, hereinafter referred to as “windows 137”, with substantially the same shape (e.g., trapezoidal) as the teeth 141, so when the PCB stator segments 135 are mounted in the housing section 110 (FIG. 2), the PCB stator segments 135 and teeth 141 are mechanically aligned.

The PCB stator assembly 130 shown in FIG. 2 has twelve PCB stator segments 135. It should be noted, however, that other embodiments of the housing assembly 200 can have a different number of PCB stator segments 135, such as where the number of PCB stator segments 135 is a multiple of the number of electrical phases of the axial field rotary energy device 100. For a three-phase axial field rotary energy device, the number of PCB stator segments 135 can be 3, 6, 9 or 18, for example, or any other multiple of the number of phases. Some embodiments of the housing assembly 200 also can have a PCB stator assembly 130 formed by one single monolithic PCB stator, rather than segments. In the housing assembly 200, shown in FIG. 2, each one of the PCB stator segments 135 can be mechanically attached to the housing section 110 by means of fasteners 170. The fasteners 170 can react to the forces applied to the PCB stator segments 135 during operation of the axial field rotary energy device 100. The fasteners 170 also can press the PCB stator segments 135 against the housing section 110, so the surfaces of the PCB stator segments 135 and corresponding housing section 110 are in contact which can facilitate the heat transfer from the PCB stator segments 135 to the housing section 110.

FIG. 4A shows a detailed view of a housing assembly 200 where several components have been removed for clarity. The embodiment of the housing section 110 shown in FIG. 4A can have an internal circumferential channel 210 that can receive the ferromagnetic core 140 providing a mechanical and thermal coupling between the ferromagnetic core 140 and the housing section 110. FIG. 4A shows an embodiment of the housing assembly 200 where the ferromagnetic core 140 is segmented. For clarity, FIG. 4A shows only one segment of the ferromagnetic core 140. Other embodiments of the housing assembly 200 can have a single monolithic ferromagnetic core 140 that circumscribes the entirety of the housing assembly 200, rather than only a portion thereof.

During the operation of the axial field rotary energy device 100, currents circulate within the PCB stator segments 135. Those currents can induce undesirable eddy current losses in the housing section 110, particularly in the areas in close contact with the PCB stator segments 135. In order to reduce eddy current losses, the housing section 110 can have circumferential grooved bands 220 (where the grooves can extend in radial directions) on both inner and outer diameter sides of the internal circumferential channel 210.

FIG. 4B shows an enlarged, partial sectional view of the housing assembly 200 along line 4B-4B of FIG. 4A. The PCB stator segment 135 can be pressed against the grooved bands 220 of the housing section 110 by means of the fasteners 170. The contact surface 136 between the PCB stator segment 135 and the grooved bands 220 can be covered with a thermal interface material, such as thermal film or thermal paste, for example, to promote a better thermal coupling between the PCB stator segment 135 and the housing section 110.

FIG. 4B further shows the windows 137 of the PCB stator segments 135 mechanically aligned with teeth 141 of the ferromagnetic core 140. The number of windows 137 in a PCB stator assembly can be the same as the number of teeth 141 in the ferromagnetic core 140. The PCB stator segment 135 also can have connecting terminals 138 that enable electrical connecting PCB stator segments 135 to each other or to an external voltage source.

It should be noted that in the housing assembly 200, the stator segments 135 are mechanically coupled to the housing section 110, so the torque is transmitted directly from the stator segments 135 to the housing section 110. The stator segments 135 are also thermally coupled to the housing section 110, so the heat generated in the stator segments 135 is transmitted to the housing section 110. Furthermore, the ferromagnetic cores 140 are mechanically and thermally coupled to the housing section 110, so the heat generated in the ferromagnetic cores 140 is transmitted to the housing section 110. The mechanical coupling between the ferromagnetic cores 140 and the housing section 110 does not transmit torque, it is only intended to hold the ferromagnetic cores 140 in place and prevent their movement during operation of the device 100, in some versions.

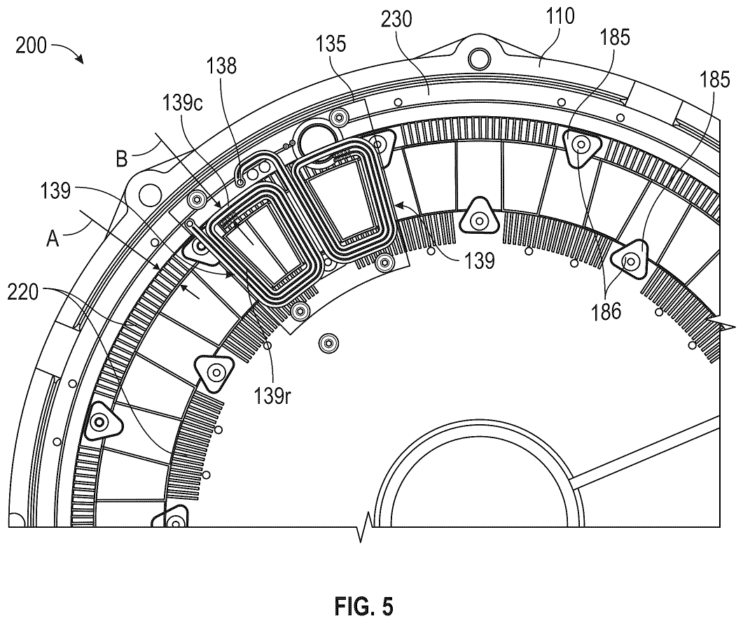

FIG. 5 shows a top view of the housing assembly 200 shown in FIG. 4A where a PCB stator segment 135 was made transparent to show internal details. The PCB stator segment 135 can have conductive traces forming a coil 139 coupled to connecting terminals 138. In the embodiment shown in FIG. 5, the coil 139 can have radial portions 139r and circumferential portions 139c coupled to the radial portions forming continuous turns of coil 139. The circumferential portions 139c can have a radial width “B”. As shown in FIG. 5, the grooved bands 220 can have a radial width “A” equal to or wider than the width “B” of the circumferential portion 139c of the coil 139. The grooves in the grooved bands 220 are oriented in a radial direction to reduce the eddy currents in the housing section 110.

Further in FIG. 5, the housing section 110 also can have a peripheral channel 230 adjacent to the outermost grooved band 220. The peripheral channel 230 can be radially aligned with the connecting terminals 138 as shown, so the peripheral channel 230 can house the conductors (not shown for clarity), such as wires and cables, to connect the PCB stators segments 135.

As shown in FIGS. 1B and 1C, the ferromagnetic cores 140 can be circumferentially and axially aligned with the magnets 125 mounted on the rotor disks 123. The alignment and proximity of magnets 125 and ferromagnetic cores 140 can generate substantial magnetic attractive forces between these components. Forces on the order of thousands of Newtons are possible, for example. In order to prevent the ferromagnetic cores 140 from detaching from the respective housing section 110, both the housing section 110 and the respective ferromagnetic core 140 can have recesses 180 (FIG. 4A) which can receive tabs 185 (FIGS. 4A, 4B and 5) that can be fastened to the housing section 110 by means of screws 186 (FIG. 5). The recesses 180 (FIG. 4A), tabs 185 (FIGS. 4B and 5) and screws 186 (FIG. 5) can be configured to keep the tabs 185 flush or just below the surface of the grooved bands 220 (see Detail “B” in FIG. 4B). This configuration does not impart localized stresses on the contact surface 136 of PCB stator segments 135 when they are attached to the housing section 110. In addition to the tabs 185, some embodiments of the housing assembly 200 can have a high strength adhesive applied to the mating surfaces of the internal circumferential channel 210 (FIG. 4A) and the corresponding ferromagnetic core 140 to strengthen the mechanical coupling between ferromagnetic cores 140 and housing section 110. In some embodiments, such adhesive can have fillers to increase its thermal conductivity to a range between about 1 to 3 W/mK, for example. This can enhance the thermal coupling between ferromagnetic cores 140 and housing sections 110. The tabs 185 and screws 186 can be made of a non-magnetic structural material such as an austenitic stainless steel alloy, for example.

Some embodiments of PCB stator segments 135 can have a plurality of PCB stator panels stacked together and aligned axially as shown in FIG. 6A. Although FIG. 6A shows a PCB stator segment 135 formed by three PCB stator panels 135.1, 135.2 and 135.3, other embodiments can have any other number of PCB panels. Furthermore, the PCB panels can be connected in series or parallel depending on the desired performance characteristics of the axial field rotary energy device 100 and, therefore, the PCB stator assembly 130.

FIG. 6B shows a schematic diagram of the coils and layers of the PCB stator panels 135.1, 135.2 and 135.3 shown in FIG. 6A, which can have a minimum of two layers with two coils per layer, for example. In FIG. 6B, panel 135.1 can have a coil 139.1.1 in a first PCB layer. Coil 139.1.1 can be coupled at one end to the terminal 138.1 (FIGS. 6A and 6B) and can be coupled at the other end to coil 139.1.2 in a second PCB layer of the PCB panel 135.1 through a plated via 131.1.1 (shown in dashed lines). Terminal 138.1 can be connected to an external electrical power source or to another terminal in another PCB stator panel, for example. Coil 139.1.2 is coupled to coil 139.1.3 on the same layer as coil 139.1.2 through a continuous common trace. Coil 139.1.3 can be coupled to coil 139.1.4 on the first layer of the PCB panel through a plated via 131.1.2. Coil 139.1.4 can be coupled to terminal 138.2.1. This pattern can be repeated in the other PCB panels (135.2 and 135.3). The PCB panel 135.1 can be connected to PCB panel 135.2 through a connector 138.2 coupling terminals 138.2.1 (on panel 135.1) and 138.2.2 (on panel 135.2). Similarly, panel 135.2 can be connected to panel 135.3 by means of connector 138.3 that couples terminal 138.3.2 (on panel 135.2) to terminal 138.3.3 (on panel 135.3). Terminal 138.4 on PCB panel 135.3 can be connected to an external electrical power source, to a neutral point (as in the case of a multi-phase PCB stator assembly), or to another terminal in another PCB stator panel, for example. The terminals 138.1, 138.2.1, 138.2.2, 138.3.2, 138.3.3 and 138.4 of the PCB stator segment 135 can be formed by plating vias, for example. Connectors 138.2 and 138.1 can be screws made of a good electrical conductor material such as brass, bronze, or beryllium-copper, for example. Connectors 138.2 and 138.1 also can be metal rivets, or a metal pin soldered to their respective terminals, for example.

As shown in FIGS. 6A and 6C, terminals 138.2.1 and 138.2.2 can be axially aligned, so when PCB stator panels 135.1 and 135.2 are stacked, the terminals line up with each other and can be selectively coupled with connector 138.2. Similarly, terminals 138.3.2 and 138.3.3 can be axially aligned, and can be selectively connected by means of connector 138.3. The alignment of pairs of terminals in adjacent layers facilitates the connection of PCB stator panels forming the PCB stator segment 135.

Although FIGS. 6A and 6B show an embodiment of a PCB stator segment 135 formed by three panels connected in series, other embodiments of PCB stator segments can have one or two panels, or more than three panels connected in series. In those cases, the number of terminals is equal to the number of panels plus one and the number of connectors is equal to the number of panels minus one. FIG. 6D shows a sectional view of an embodiment of a PCB stator segment 135 with 4 layers illustrating the rule. In the embodiment shown in FIG. 6D, the PCB stator segment comprises 4 PCB panels (135.1, 135.2, 153.3 and 135.4). Terminal 138.1 in panel 135.1 can be connected to an external electrical source or to another PCB stator segment. Terminals 138.2.1 in panel 135.1 and 138.2.2 in panel 135.2 can be axially aligned and connected to each other through connector 138.2. Terminals 138.3.2 in panel 135.2 and 138.3.3 in panel 135.3 can be axially aligned and connected to each other through connector 138.3. Terminals 138.4.3 in panel 135.3 and 138.4.4 in panel 135.4 can be axially aligned and connected to each other through connector 138.4, and terminal 138.5 in panel 135.4 can be connected to another PCB stator panel, to an external electrical source, or to a neutral point (as in the case of a multi-phase PCB stator assembly), in some versions.

As shown in FIG. 6E, some embodiments of a PCB stator segment 135 can have all PCB panels connected in parallel. For example, a PCB stator segment 135 can have three PCB panels 135.1, 135.2 and 153.3, with each one having a first terminal 138.1 and second terminal 138.2. The first terminals 138.1 can be axially aligned, so they can be connected to an external electrical source, or to another PCB stator segment 135 (not shown) by a single conductor such as a copper wire, copper bar, or copper cable soldered to the first terminals 138.1, for example. The second terminal 138.2 can be similarly axially aligned, so they can be connected to another PCB stator segment 135 (not shown), to an external electrical source, or to a neutral point (as in the case of a multi-phase PCB stator assembly) by a single conductor such as a copper wire, copper bar, or copper cable soldered to the second terminals 138.2, for example.

Referring to FIG. 6F, some embodiments of a PCB stator segment 135 can have a combination of series and parallel connected panels. For example, the PCB stator segment 135 can comprise four PCB panels 135.1, 135.2, 153.3 and 135.4 that form two series of connected pairs, namely PCB panels 135.1 and 135.2, and PCB panels 135.3 and 135.4. In FIG. 5, terminals 138.1 in panels 135.1 and 135.3 can be aligned axially and can be connected to an external electrical source, or to another PCB stator segment 135, by a single conductor such as a copper wire, copper bar, or copper cable soldered to the terminals, for example. Further, in FIG. 6F, terminals 138.2.1 in panel 135.1 and 138.2.2 in panel 135.2 can be axially aligned and connected to each other through connector 138.2. Terminals 138.3.3 in panel 135.3 and 138.3.4 in panel 135.4 can be aligned axially and connected to each other through connector 138.3. Finally, terminals 138.4 in panels 135.2 and 135.4 can be axially aligned and can be connected to another PCB stator segment, to an external electrical source, or to a neutral point (as in the case of a multi-phase PCB stator assembly) by a single conductor such as a copper wire, copper bar, or copper cable soldered to the terminals, for example.

It should be understood that the examples of PCB stator segments shown in FIGS. 6A, 6B, 6C, 6D, 6E and 6F are not limiting. Other embodiments of PCB stator segments are possible, including embodiments where the PCB stator segments 135 can have more than two windows 137 (FIG. 6A), such as four, six or any other even number of windows, for example. FIG. 6G shows an example of a PCB stator segment 135 with four windows 137. Embodiments of PCB stator segments 135 can have any number of PCB panels, and PCB panels can have any even number of windows. Although FIGS. 5 and 6B show PCB stator segments 135 having coils with two turns, other embodiments of PCB stator segments 135 can have coils with one turn or more than two turns. Furthermore, some embodiments of housing assembly 200 can have PCB stator assemblies 130 comprising any number of monolithic PCB panels (i.e., non-segmented panels).

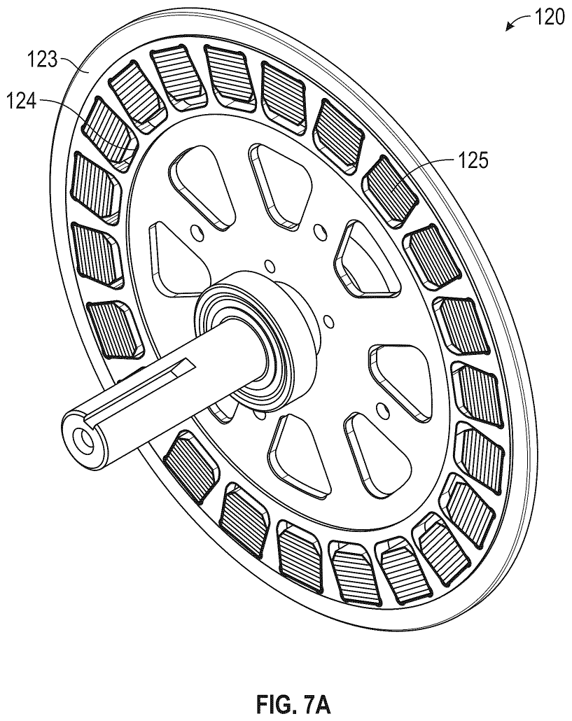

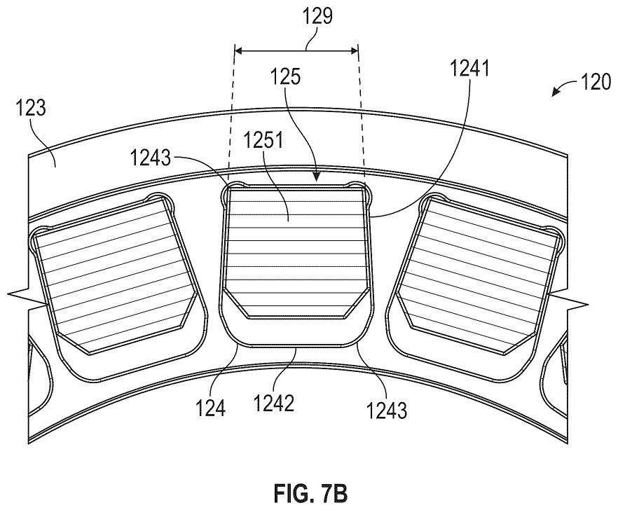

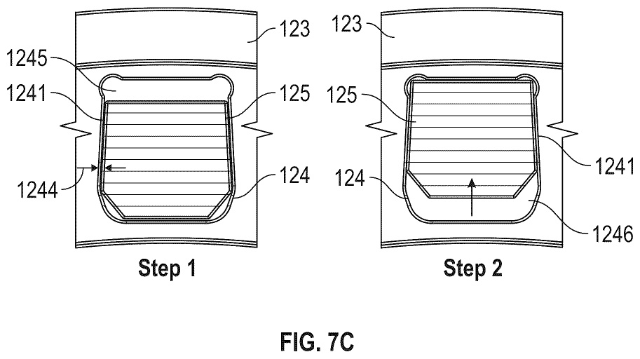

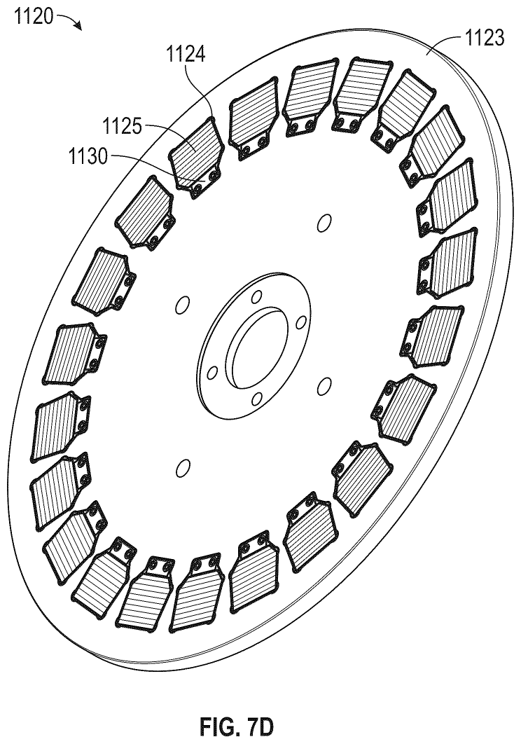

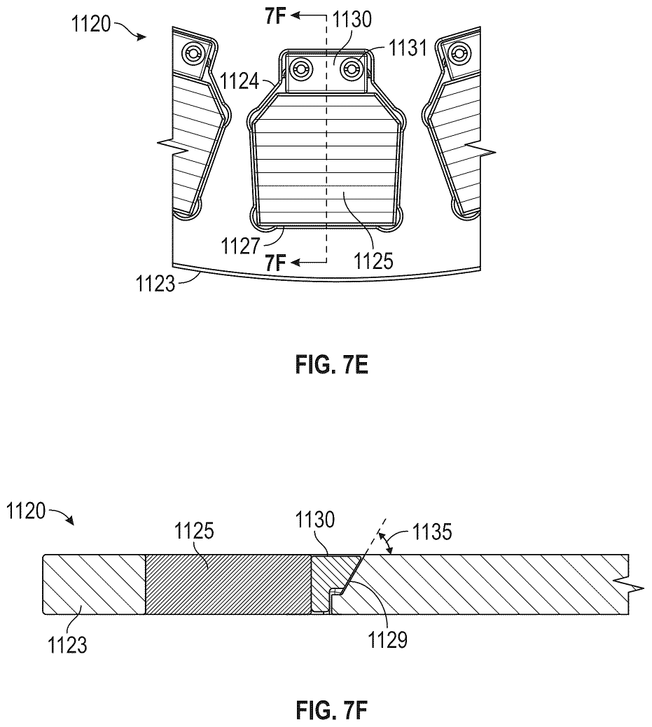

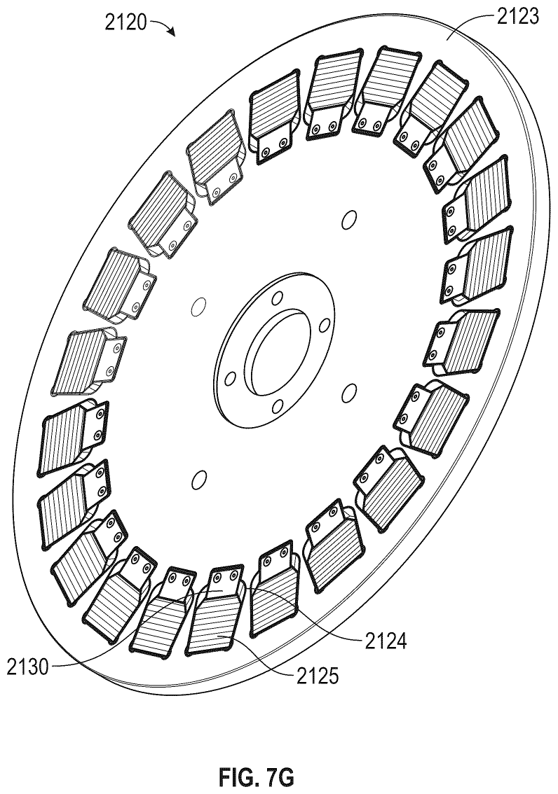

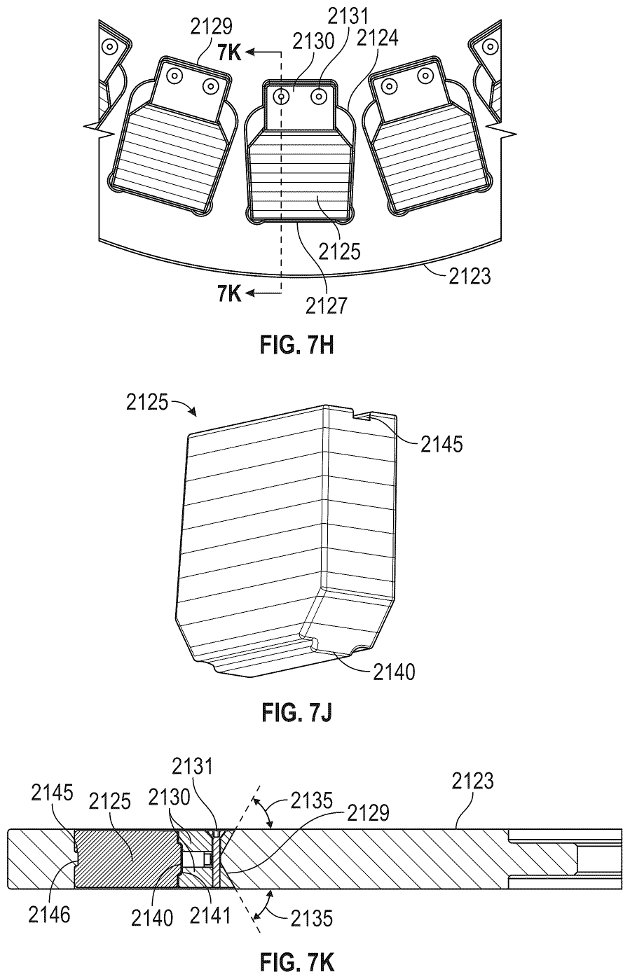

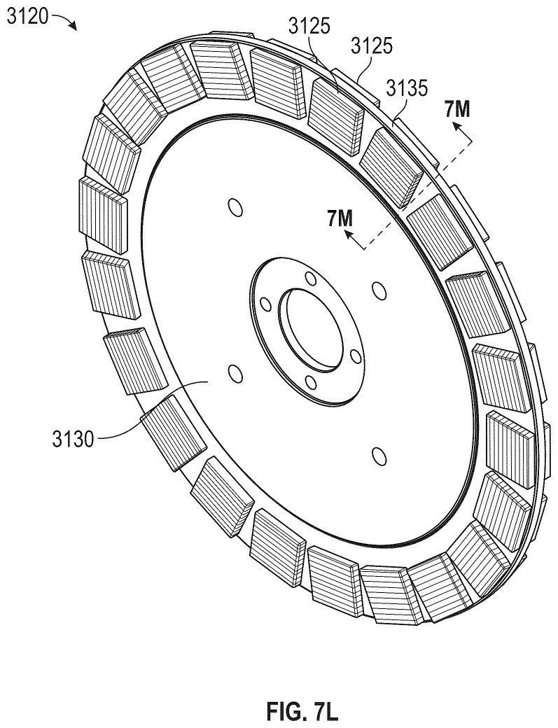

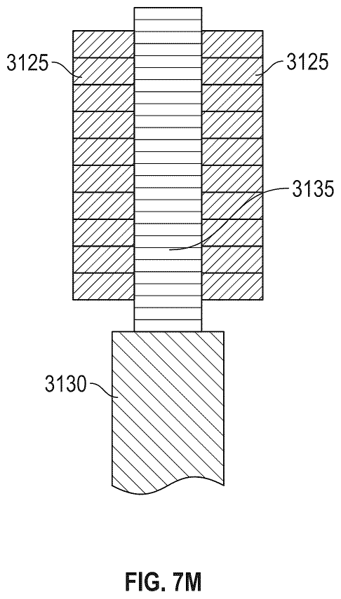

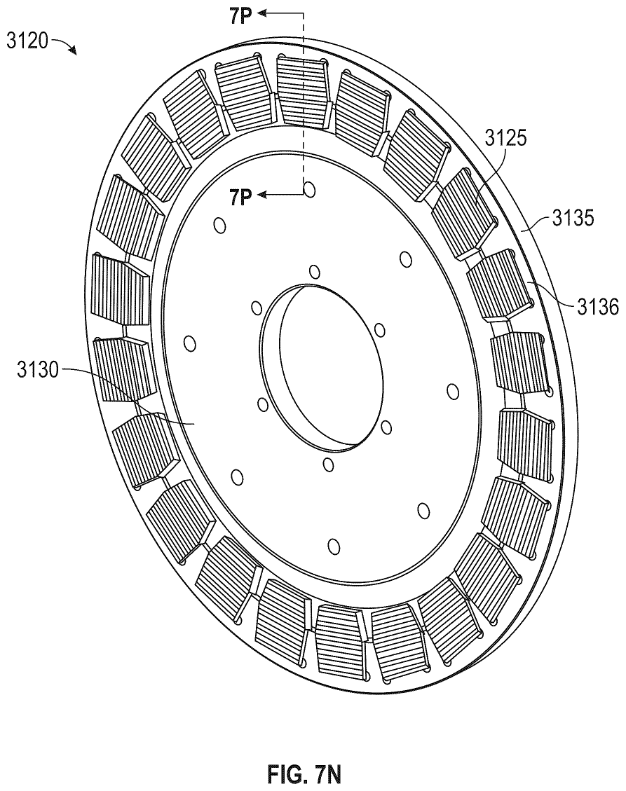

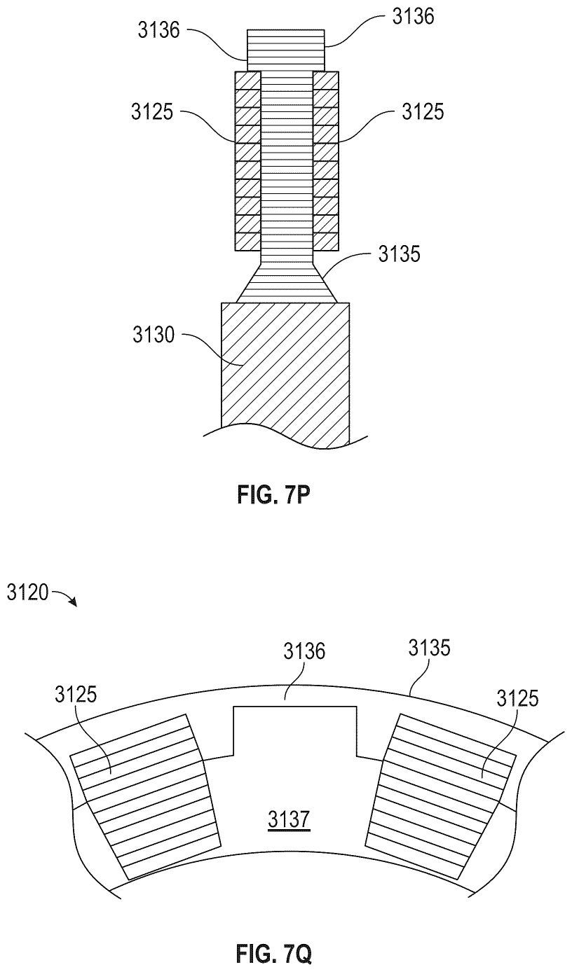

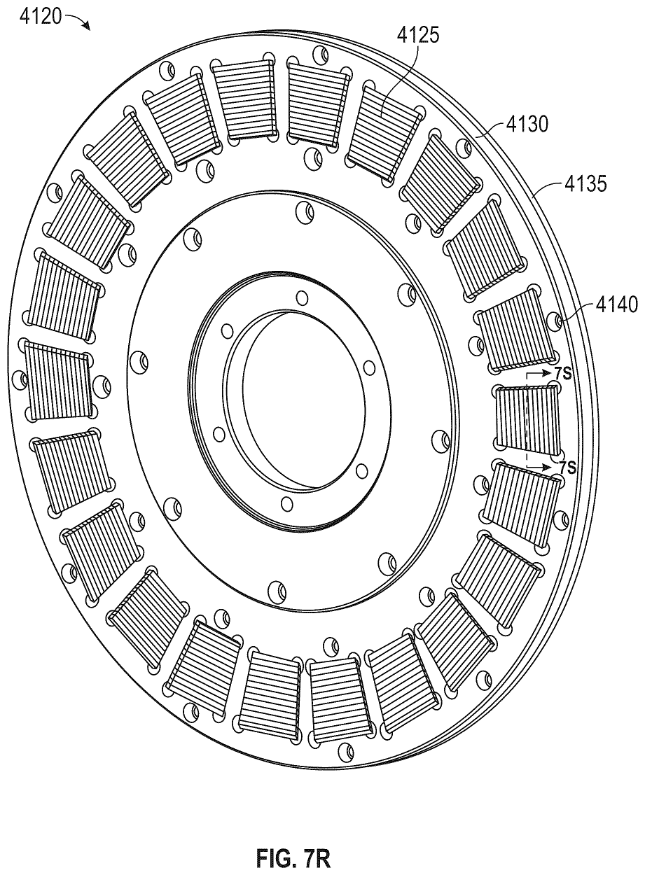

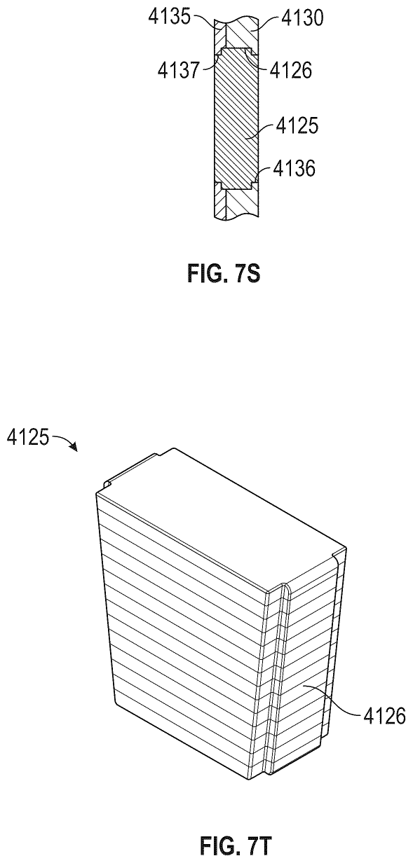

FIGS. 7A and 7B show an embodiment of a rotor 120 for the axial field rotary energy device 100 where its rotor disk 123 can have a plurality of windows 124, and each window 124 can have one magnet 125. The rotor disk 123 can be made of a non-conducting structural material, such as glass fiber composite or carbon fiber composite, for example. The magnet 125 can comprise a plurality of magnet segments 1251 (FIG. 7B) that are bound together while electrically insulated from each other to mitigate eddy current losses in the magnets 125 during the operation of the axial field rotary energy device 100. Each magnet segment 1251 can be oriented in a substantially circumferential direction relative to the axis of rotation 121 (FIG. 1B). In other words, the largest dimension of the magnet segment 1251 can be oriented in a substantially circumferential direction. The magnet segments 1251 can be stacked in a radial direction relative to the axis of rotation 121 (FIG. 1B). The embodiment shown in FIG. 7B has ten segments, but some embodiments can have magnets 125 with a different number of magnet segments 1251, and other embodiments can have singular, monolithic magnets 125. Each window 124 can have sides 1241 that are aligned in a substantially radial direction (relative to axis of rotation 121) and are coupled to other sides 1242, which can be aligned in a substantially tangential (or circumferential) direction with round corners 1243 between them. The round corners 1243 can help reduce stresses on the rotor disk 123 imparted by the magnets 125 when the rotor 120 is spinning. The sides 1241 of windows 124 and corresponding sides of magnets 125 can form an acute angle 129. When the rotor 120 rotates, the centrifugal force acting on the magnet 125 contributes to wedging it into the window 124. The acute angle 129 can vary between about 3 degrees and about 5 degrees, for example.

The acute angle 129 also can facilitate the assembly of magnets 125 in the windows 124. During the magnet assembly process, in STEP 1 (FIG. 7C), the magnet 125 is inserted in the window 124 of the rotor disk 123 near the bottom (i.e., inner diameter) of window 124, so gaps 1244 can form between the radial sides 1241 of the window 124 and the corresponding sides of the magnet 125. The radial sides of the magnet 125 can be coated with a high strength adhesive, for example. In STEP 1, an opening 1245 can exist on the narrow end (i.e., outer diameter) of the window 124. In STEP 2 of FIG. 7C, the magnet 125 is pushed radially outward into the opening 1245, which closes the opening 1245 and the gaps 1244 while wedging the magnet 125 against the window sides 1241. At the end of STEP 2, an opening 1246 is formed at the wider end (i.e., inner diameter) of the window 124 when the magnet 125 is firmly wedged in the window 124.

FIGS. 7D, 7E and 7F show an alternate embodiment of the axial field rotary energy device rotor 1120 where the rotor disk 1123 can have windows 1124 configured to receive magnets 1125. The rotor disk 1123 can be made of a non-conducting structural material, such as glass fiber composite or carbon fiber composite. In addition, wedges 1130 can be attached to the rotor disk 1123 by means of fasteners 1131 (FIG. 7E). The wedges 1130 can press against the magnets 1125 and push them against wall 1127 (FIG. 7E) of the window 1124. Each window 1124 of the rotor disk 1123 can have a slanted surface 1129 (FIG. 7F) forming an angle 1135 relative to the outer surface of the rotor disk 1123. The wedge 1130 also can have a diagonal surface that mates with surface 1129 at the respective angle 1135. When fasteners 1131 are tightened against the rotor disk 1123, the wedge 1130 can move down and push against the respective magnet 1125 and apply a radially oriented clamping force to it.

FIGS. 7G, 7H, 7J and 7K show another embodiment of the axial field rotary energy device rotor 2120 with an alternate magnet retainment version. In this embodiment, the rotor disk 2123 can have a plurality of windows 2124 configured to receive magnets 2125. The rotor disk 2123 can be made of a non-conducting structural material, such as glass fiber composite or carbon fiber composite. The radially innermost surface 2129 of the windows 2124 can have two slanted sections forming angles 2135 (FIG. 7K) with the respective major surfaces of the rotor disk 2123. The angles 2123 can range from about 50 degrees to about 80 degrees, for example. Each window 2124 also can be configured to receive a pair of wedges 2130 that can have diagonal surfaces that mate with the two slanted sections of surfaces 2129, respectively (FIG. 7K). The wedges 2130 can be coupled by fasteners 2131 and can be configured to form a groove 2141 (FIG. 7K) that can engage a ridge 2140 (FIGS. 7J and 7K) in a first surface of the magnets 2125. In addition, each window 2124 can have a ridge 2146 (FIG. 7K) located at the radially outermost surface 2127 (FIG. 7H) of the window, which can engage a notch 2145 (FIGS. 7J and 7K) in a second surface of the magnet 2125 (FIG. 7J) opposite to the first surface. When the fasteners 2131 are tightened, they can bring the wedges 2130 together causing the wedges to slide over the slanted sections of the window surface 2129 and push the magnet 2125 against the radially outermost surface 2127 of the window 2124. This can wedge the magnet notch 2145 against ridge 2146 securing the magnet 2125 in the window 2124.

FIGS. 7L and 7M show an embodiment of an axial field rotary energy device rotor 3120 having magnets 3125 bonded on both sides of a flange 3135 coupled to a rotor disk hub 3130. The rotor disk hub 3130 can be made of a structural material such as A36 steel, or carbon fiber composite for example. The flange 3135 is coupled to the rotor disk hub 3130 and can be laminated. For example, the flange 3135 can be made of a continuously wound strip of a soft magnetic material such as a strip of 0.5 mm thick M-19 silicon steel, 0.25 mm thick HF-10 silicon steel, or 0.25 mm thick Permalloy 80. The flange 3135 can be attached to the hub 3130 through any suitable method such as welding, gluing or fastened with bolts, for example. The magnets 3125 can be bonded to the flange 3135 by means of a high strength adhesive or other suitable method.

FIGS. 7N, 7P and 7Q show an alternate embodiment of an axial field rotary energy device rotor 3120 where the flange 3135 can have ridges 3136 along the outer circumferential edge of the flange 3135. The flange 3135 can be formed as described above. The flange 3135 can be machined to form the ridges 3136 and pockets 3137. The pockets 3137 can receive magnets 3125 as shown in FIG. 7Q, where one magnet 3125 has been removed to show the edges of pocket 3137. During assembly, the magnets 3125 can be pushed into the pocket 3137 and against the ridges 3136. The magnets 3125 can be further secured in place by means of a high strength adhesive. The placement of magnets 3125 in pockets 3137 in conjunction with a high strength adhesive provides additional support to magnets during operation of the axial field rotary energy device at high speeds. The flange 3135 of the rotor 3120 shown in FIGS. 7N and 7P can be made of soft magnetic material such as a wound strip of 0.5 mm thick M-19 silicon steel, 0.25 mm thick HF-10 silicon steel, or 0.25 mm thick Permalloy 80, for example. The magnets 3125 can comprise a plurality of magnet segments similarly as depicted in FIG. 7B.

FIGS. 7R and 7S show an embodiment of an axial field rotary energy device rotor 4120 where the rotor can comprise a rotor disk 4130 having rotor windows that receive magnets 4125. The rotor disk 4130 can be made of a non-conducting structural material, such as glass fiber composite or carbon fiber composite. The rotor windows in the rotor disk 4130 can have lips 4136 (FIG. 7S) along their radial edges that can engage ridges 4126 (FIGS. 7S and 7T) along the radial sides of the magnets 4125. The rotor disk 4130 can be configured to receive a ring 4135 that can have ring windows that are complementary to the rotor windows. The ring 4135 can be made of a non-conducting structural material, such as glass fiber composite or carbon fiber composite. The sides of the ring windows of the ring 4135 can have lips 4137 (FIG. 7S) that can engage the ridges 4126 on the sides of the magnets 4125. The ring 4135 can be coupled to the rotor disk 4130 with fasteners (not shown) in respective holes 4140 (FIG. 7R) to secure the magnets 4125 between the rotor disk 4130 and the ring 4135. In some embodiments, a high strength adhesive can be applied between the ridges 4126 of the magnets 4125 and the respective sides of the rotor windows in the rotor disk 4130. The magnets 4125 can comprise magnet segments as depicted in and described for FIG. 7B.

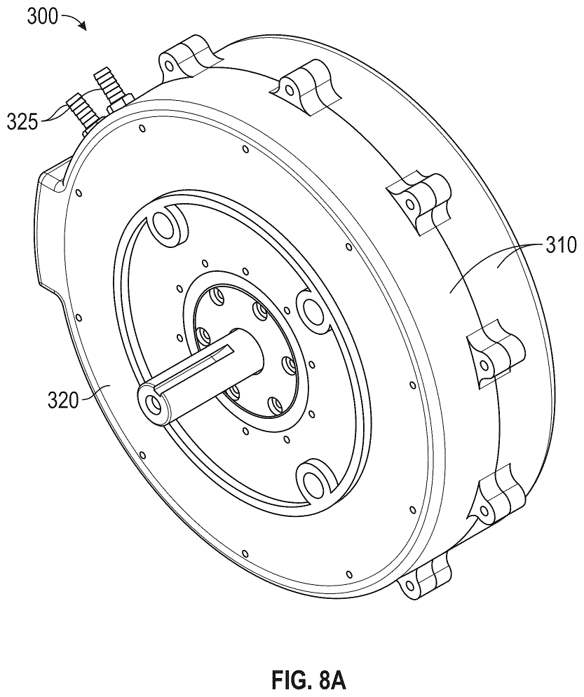

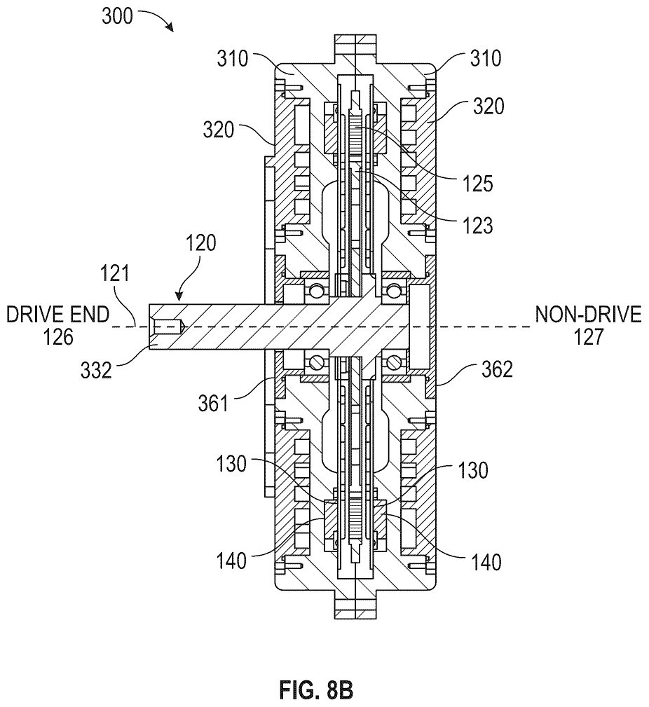

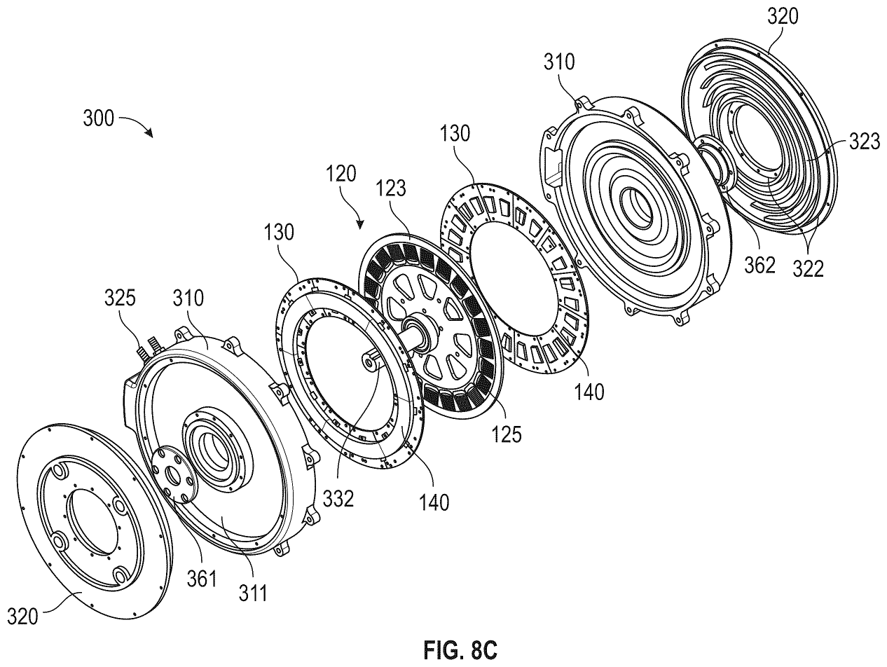

While the embodiment of the axial field rotary energy device 100 shown in FIGS. 1A, 1B and 1C can be air cooled, other embodiments can be equipped to operate with a liquid coolant. For example, an axial field rotary energy device 300 is depicted in FIGS. 8A, 8B and 8C. The axial field rotary energy device 300 can share many of the same components and features as the axial field rotary energy device 100. Similar to the axial field rotary energy device 100, the axial field rotary energy device 300 can have two housing sections 310 that are coaxially aligned with the axis 121 of rotation (FIG. 8B) and coupled to each other. Each housing section 310 can have an external circumferential channel 311 (FIG. 8C) that can receive a respective cooling plate 320. The cooling plates 320 and housing sections 310, collectively, define a volume that can contain and circulate a liquid coolant to cool the axial field rotary energy device 300. The liquid coolant can be a mixture of 70% water and 30% ethylene glycol, or 65% water and 35% propylene-glycol, for example. The cooling plates 320 can be fastened to the housing sections 310 with fasteners or screws, for example. The axial field rotary energy device 300 can have slots with seals 322 (FIG. 8C) to prevent coolant leaks. The seals 322 can be o-rings, formed-in-place-gaskets or pre-formed (extruded) gaskets, for example. Each cooling plate 320 can have circumferential walls 323 that define a circulation pattern for the liquid coolant.

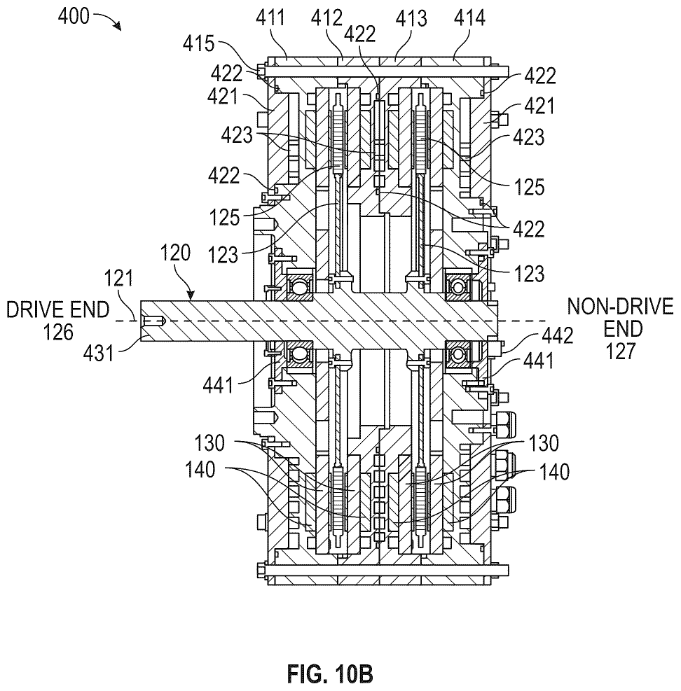

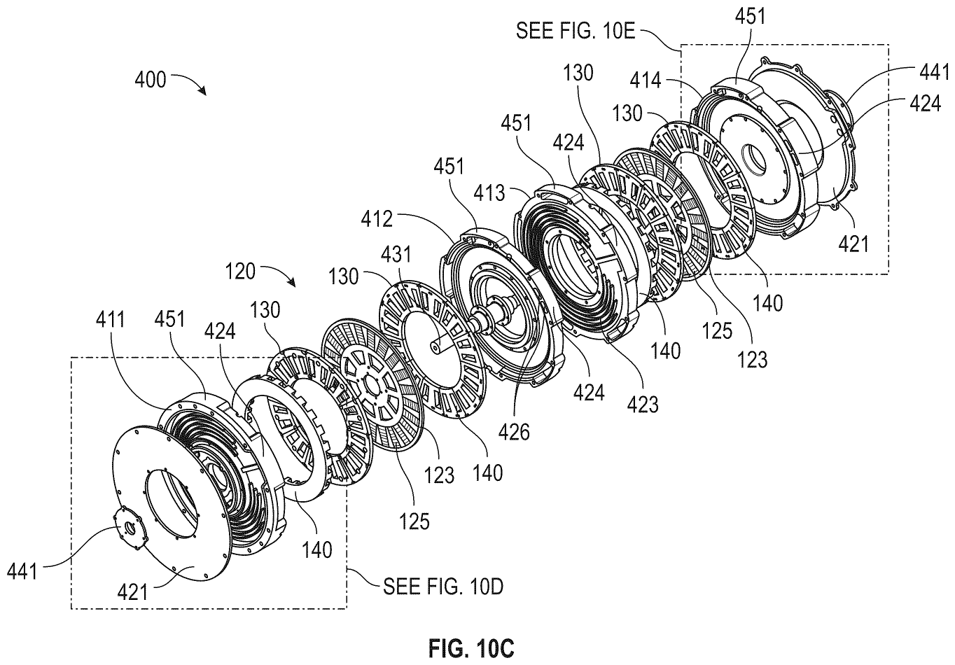

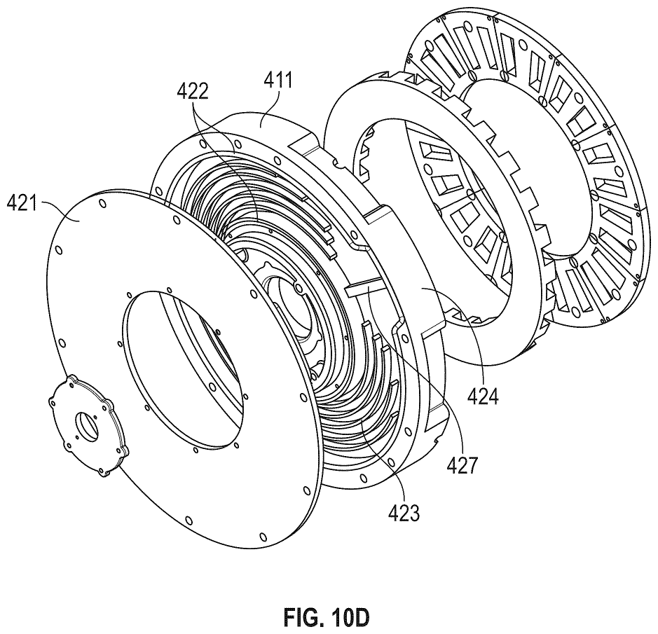

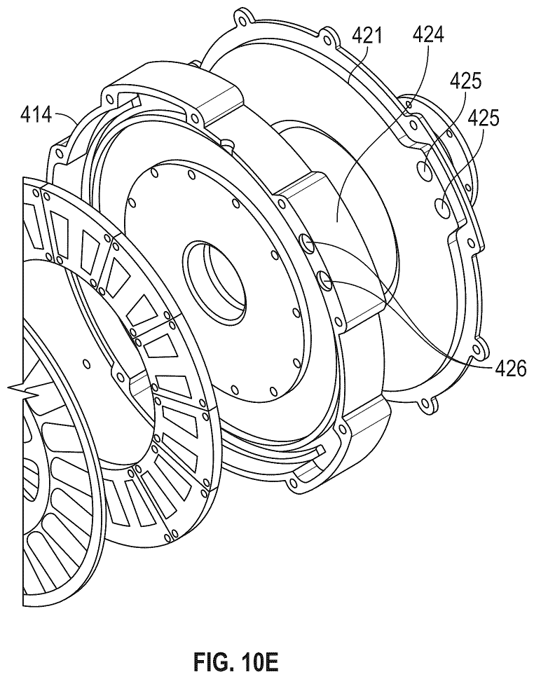

At least one of the housing sections 310 can have ports 325 whereby the liquid coolant can enter and exit the volume defined by the cooling plates 320 and the respective housing sections 310. The coolant can move between the cooling plates 320 via hoses, tubes or channels built into the housing structure, as shown in FIGS. 10C-10E. The ports 325 can be connected to hoses with hose barbs, threaded connectors or quick-connect style connectors, for example. Although FIGS. 8A and 8C depict the axial field rotary energy device 300 with the ports 325 oriented radially on one of the housing sections 310, other embodiments of the axial field rotary energy device 300 can have the ports 325 oriented axially at either housing section 310.

Similar to the axial field rotary energy device 100, the axial field rotary energy device 300 can have a rotor 120 coaxial with the housing sections and positioned between them. The rotor 120 can rotate about the axis of rotation 121 (FIG. 8B). The rotor 120 can comprise a shaft 332 coaxial with the axis of rotation 121, and a rotor disk 123 attached to the shaft 332 and coaxial with the axis of rotation 121. The rotor disk 123 can carry magnets 125, which can be monolithic or segmented as described above. The axial field rotary energy device 300 can have a drive end 126 where the shaft 332 extends in the axial direction through the bearing cap 361 to enable coupling the axial field rotary energy device 300 to a load, in case the device 300 is a motor or to a prime mover, in case the device 300 is a generator. The axial field rotary energy device 300 depicted in FIGS. 8A, 8B and 8C does not have a shaft extension on the non-drive end side 127, therefore the bearing cap 362 on the non-drive end side 127 can be blind. However, some embodiments of the axial field rotary energy device 300 can have a non-drive end shaft extension that can be coupled to a speed sensor, for example, in which case the bearing cap 362 can have an opening for an extension of the shaft 332. Similarly to the axial field rotary energy device 100, the axial field rotary energy device 300 can have PCB stator assemblies 130 coaxial with the rotor 120 relative to the axis of rotation 121. Each PCB stator assembly 130 can be mechanically coupled to a respective housing section 310 and can comprise a monolithic PCB stator or PCB stator segments having a plurality of conductive layers of copper foil laminated together with layers of an insulating material such as FR4 epoxy-glass laminate, for example.

The axial field rotary energy device 300 can further comprise ferromagnetic cores 140 that are mechanically and thermally coupled to each respective housing section 310 (FIG. 8B). This configuration allows the heat generated by hysteretic and eddy current losses in the ferromagnetic cores 140 to be conducted to the housing section 310 and removed by the liquid coolant circulating in the volume defined by the cooling plate 320 and housing section 310. In some embodiments, the axial field rotary energy device 300 can have a thermal interface material between the ferromagnetic core 140 and the respective housing section 310 to further enhance the heat conduction. Similar to the axial field rotary energy device 100, the PCB stator assemblies 130 can be mechanically coupled to the corresponding housing section 310, so the torque is transmitted directly from the PCB stator assemblies 130 to the housing section 310.

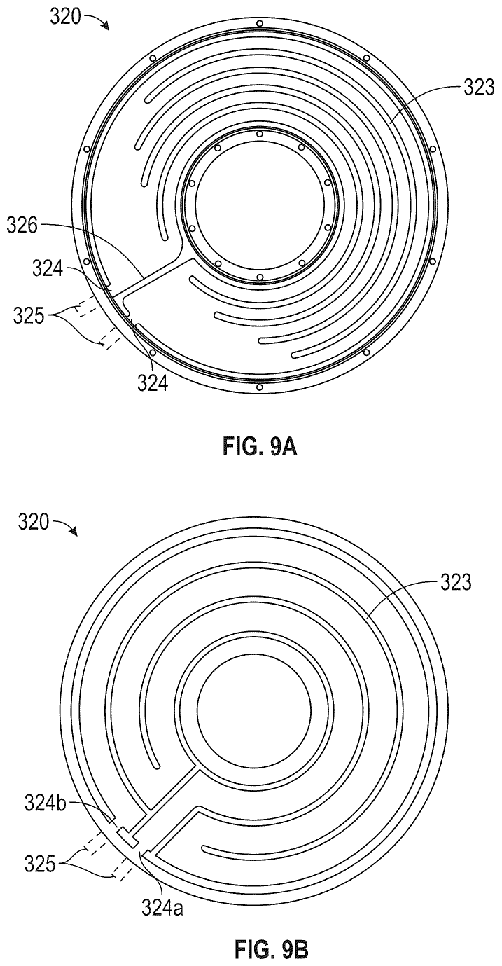

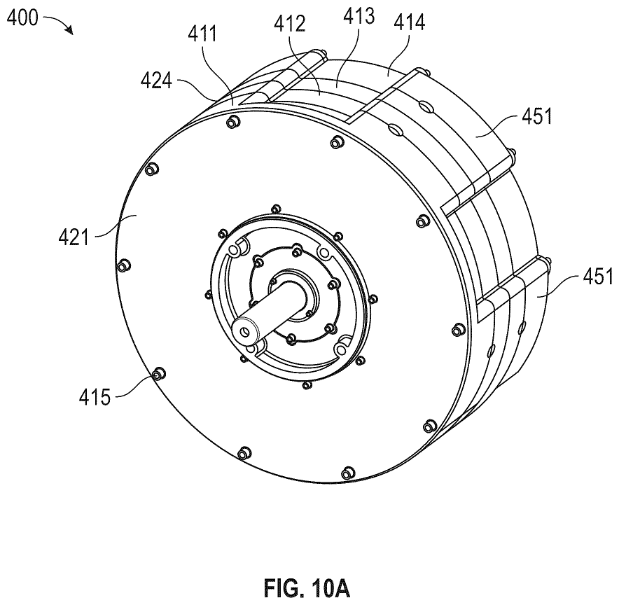

FIG. 9A shows an embodiment of the cooling plate 320 where the circumferential walls 323 define a plurality of parallel paths for the liquid coolant which can enter and exit the cavity of the cooling plate 320 through openings 324 aligned and coupled with the ports 325 of the housing section 310. A wall 326 between openings 324 prevent the incoming coolant from mixing with the outgoing coolant. An alternate embodiment of the cooling plate 320 is shown in FIG. 9B where the circumferential walls 323 form a labyrinth or serpentine path that directs the coolant from one inlet opening 324a to an outlet 324b. The inlet 324a and outlet 324b can be aligned and coupled with the housing section ports 325. Other embodiments of the cooling plate 320 can have two or more serpentine paths in parallel.

FIGS. 10A through 10E depict yet another embodiment of a liquid cooled, axial field rotary energy device 400 that can share many components and features from the previously described embodiments. Examples of the axial field rotary energy device 400 comprise a rotor 120 with two rotor disks 123, and four PCB stator assemblies 130. In one version, the axial field rotary energy device 400 can have four housing sections 411, 412, 413 and 414 (e.g., two outer ones, and two inner ones) that are coupled to each other, and coaxial with the axis of rotation 121 (FIG. 10B). Covers 421 on the ends of the axial field rotary energy device 400, in conjunction with their adjacent and respective housing sections 411 and 414, define cavities in which a liquid coolant circulates to cool the device 400. The liquid coolant can be a mixture of 70% water and 30% ethylene glycol, or 65% water and 35% propylene-glycol, for example. The outer sides of the two outer housing sections 411 and 414 facing the respective covers 421 can have recesses with internal walls 423 (FIGS. 10B and 10D) that define a circulation path for the liquid coolant.

Similarly, the two inner housing sections 412 and 413 can have recesses facing each other with complementary internal walls 423 (FIGS. 10B and 10C) that define a cavity and path for the liquid coolant to circulate. The internal walls 423 in all housing sections 411-414 can be arranged in parallel streams, or form a serpentine path as shown in FIGS. 9A and 9B respectively, for example.

Each of the housing sections 411-414 can have one or more first lobes 424 (see FIGS. 10A, 10C, 10D and 10E) that can be hollow and located adjacent exteriors thereof. When the housing sections 411-414 are coupled together, such as with fasteners 415 (FIGS. 10A and 10B), the first lobes 424 form a manifold, collectively, that can distribute the liquid coolant to the cavities in the outer housing sections 411, 414, and to the cavity between the inner housing sections 412, 413. Each of the first lobes 424 can be bisected internally by a wall 427 (FIG. 10D) that prevents the incoming coolant flow from mixing with the outgoing coolant flow. Seals 426 (FIG. 10E) can prevent coolant leaks at the interfaces between the housing sections 411-414 where the first lobes 424 are coupled. The seals 426 can be o-rings, formed-in-place-gaskets, or pre-formed (extruded) gaskets, for example. The first lobes 424 can be aligned and coupled to openings 425 (FIG. 10E) in one of the covers 421. The openings 425 can be the liquid coolant inlet and outlet ports and can be connected to hoses with hose barbs, threaded connectors, or quick connect style connectors, for example.

The outer housing sections 411 and 414 can have slots at their interfaces with the covers 421, and one or more seals 422 (FIGS. 10B and 10D) to prevent coolant leaks. Similarly, one of the inner housing sections 412 or 413 can have slots at their interface and one or more seals 422 (FIG. 10B). The seals 422 can be o-rings, formed-in-place-gaskets, or pre-formed (e.g., extruded) gaskets, for example.

The rotor 120 can be coaxial with the housing sections 411-414 and comprise a shaft 431 that can rotate about the axis of rotation 121. Two rotor disks 123 can be attached to the shaft 431 and carry magnets 125 (FIGS. 10B and 10C). The magnets 125 can be monolithic or segmented. The axial field rotary energy device 400 can have a drive end 126 where the shaft 431 extends axially through the bearing cap 441 to enable coupling the axial field rotary energy device 400 to a load, in case the axial field rotary energy device 400 is a motor, or to a prime mover, in case the axial field rotary energy device 400 is a generator. In the embodiment shown in FIG. 10B, the shaft 431 extends outwardly through the bearing cap 441 on the non-drive end side 127, where it can be coupled to a speed sensor 442, for example. In other embodiments, the axial field rotary energy device 400 may not have a non-drive end shaft extension, and the bearing cap 441 on that side can be blind.

The axial field rotary energy device 400 can have four PCB stator assemblies 130 coaxial with the rotor 120 relative to the axis of rotation 121. One of the PCB stator assemblies 130 is positioned on each side of a respective rotor disk 123. Each PCB stator assembly 130 can be mechanically coupled to a respective housing section 411, 412, 413 and 414. Each PCB stator assembly 130 can comprise a monolithic PCB stator or PCB stator segments having a plurality of conductive layers of copper foil laminated together with layers of an insulating material such as FR4 epoxy-glass laminate, for example. Similar to the axial field rotary energy device 100, the PCB stator assemblies 130 can be mechanically coupled to the respective housing sections 411-414, so the torque is transmitted directly from the PCB stator assemblies 130 to the respective housing sections 411-414.

The axial field rotary energy device 400 can further comprise four ferromagnetic cores 140 that are mechanically and thermally coupled to each respective housing section 411, 412, 413 and 414 (FIG. 10B). The heat generated by hysteretic and eddy current losses in the ferromagnetic cores 140 can be conducted to the respective housing sections 411-414, and removed by the liquid coolant circulating in the cavities defined by the housing sections 411, 412, 413 and 414 and the covers 421. In some embodiments, the axial field rotary energy device 400 can have a thermal interface material between the ferromagnetic cores 140 and the respective housing sections 411-414 to further enhance the heat conduction.

Each of the housing sections 411, 412, 413 and 414 can have one or more second lobes 451 (FIGS. 10A and 10C) that can be hollow and located adjacent an exterior thereof. The second lobes 451 can be rotationally offset from the first lobes 424, as shown. When the housing sections 411-414 are assembled, the second lobes 451 collectively form a cavity to contain conductors (e.g., cables and wires) to interconnect the PCB stator assemblies 130. The second lobes 451 also can connect the PCB stator assemblies 130 to an external electric power source, such as a variable frequency drive (VFD) if the axial field rotary energy device 400 is a motor, or to an external load or power converter if the axial field rotary energy device 400 is a generator. The cavity formed by the second lobes 451 also can be used to carry signal cables from temperature sensors, accelerometers, or other sensing devices, for example. While FIG. 10A shows each housing section 411-414 with two second lobes 451, other embodiments can include a different number of second lobes 451.

Although the axial field rotary energy device 400 of FIGS. 10A-10E is shown with two rotor disks 123 and four PCB stator assemblies 130 mounted in four housing sections 411-414, respectively, other embodiments of the axial field rotary energy device 400 can have three or more rotor disks 123. In those examples, the number of PCB stator assemblies and number of housing sections, each would be two times the number of rotor disks.

At least one rotor and air cooling

1. An axial field rotary energy device, comprising:

a housing having housing sections coaxially coupled along an axis of rotation, each housing section comprising:
an internal circumferential channel coaxial with the axis;
a ferromagnetic core mechanically and thermally coupled to the internal circumferential channel and comprising a toroidal yoke with teeth protruding in an axial direction relative to the axis, and the teeth are equally spaced apart from each other in a circumferential direction relative to the axis;
a printed circuit board (PCB) stator assembly mechanically and thermally coupled to the housing section, coaxial with the axis, and having stator windows through which the teeth of the ferromagnetic core protrude in the axial direction, wherein a quantity of the stator windows equals a quantity of the teeth; and
fins on an exterior of the housing section that extend in a radial direction relative to the axis;

an air gap located axially between the ferromagnetic cores when the respective housing sections are coupled together;

a rotor coaxial with the axis and axially positioned at a center of the air gap, the rotor comprising:
a rotor disk comprising a non-conducting material and having rotor windows that are equally spaced from each other in a circumferential direction;
magnets comprising magnet segments, wherein the magnet segments are oriented circumferentially relative to the axis and are bonded together and electrically insulated from each other, and each magnet is coupled to a respective rotor window of the rotor disk; and
radial surfaces of the rotor windows and respective magnet surfaces define an acute angle with narrow portions of the rotor windows adjacent an outer diameter of the rotor disk.
a fan coupled to the rotor and external to the housing for rotation with the rotor;
and
a shroud configured to guide airflow from the fan over the fins of the housing sections.

2. The device wherein the ferromagnetic cores comprise a soft ferromagnetic material.

3. The device wherein the ferromagnetic cores comprise a soft magnetic composite (SMC) material.

4. The device wherein each ferromagnetic core is segmented, and core split lines that segment the ferromagnetic core are located at or adjacent to a respective radial centerline of respective ones of the teeth.

5. The device wherein the ferromagnetic cores are laminated and each comprises a wound strip of soft ferromagnetic alloy.

6. The device further comprising recesses that are complementary in both the housing sections and the ferromagnetic cores, and tabs are located in respective ones of the recesses to couple a respective housing section to a respective ferromagnetic core to prevent the respective ferromagnetic core from detaching from the respective housing section.

7. The device wherein each PCB stator assembly comprises PCB panels that are discrete, stacked together and aligned coaxially.

8. The device wherein pairs of PCB panels have terminals aligned coaxially and coupled with a connector to form a series connection between the respective pairs of PCB panels.

9. The device wherein the PCB panels have terminals aligned coaxially and connected in parallel with connectors.

10. The device wherein each PCB stator assembly comprises PCB stator segments.

11. The device wherein the axial field rotary energy device is configured to comprise N electric phases, and a quantity of the PCB stator segments is a multiple of N.

12. The device wherein:
each housing section has grooved bands adjacent to inner and outer diameter sides of the internal circumferential channel, wherein, relative to the axis, grooves in the grooved bands are oriented in a radial direction, and the grooved bands comprise a radial width A;
each PCB stator assembly has coils and each coil has end turns with a radial width B;
each PCB stator assembly is positioned in a respective housing section such that respective end turns radially align with respective grooved bands of the respective housing section; and
the width A is equal to or greater than width B such that the grooved bands overlap the end turns, respectively.

13. The device wherein the housing section further comprises a peripheral channel outboard of the outermost grooved band, the peripheral channel is radially aligned with terminals of a respective PCB stator assembly, and the peripheral channel comprises conductors for electrical connections with the terminals of the respective PCB stator assembly.

14. The device wherein the ferromagnetic cores comprise a soft ferromagnetic material.

15. The device wherein the ferromagnetic cores comprise a soft magnetic composite (SMC) material.

16. The device wherein the ferromagnetic cores are segmented, and core split lines segmenting the ferromagnetic cores are located at or adjacent to a radial centerline of respective ones of the teeth.

17. The device wherein the ferromagnetic cores are laminated and each comprises a wound strip of soft ferromagnetic alloy.

18. The device wherein each ferromagnetic core has recesses that are coupled to tabs fastened to the respective housing section to prevent the ferromagnetic core from detaching from the housing section.

19. The device wherein each PCB stator assembly comprises PCB panels that are discrete, stacked together and aligned axially.

20. The device wherein pairs of PCB panels have terminals aligned axially and coupled with a connector to form a series connection between PCB panels.

21. The device wherein the PCB panels have terminals aligned axially and connected in parallel with connectors.

22. The device wherein each PCB stator assembly comprises PCB stator segments.

23. The device wherein the axial field rotary energy device has N electric phases, and a total number of the PCB stator segments is a multiple of N.

24. The device wherein the rotor comprises wedges that engage respective otor windows, and, relative to the axis, the wedges apply a radially-oriented clamping force to respective magnets.

At least one rotor and liquid cooling

1. An axial field rotary energy device, comprising:

an axis of rotation;

a housing having at least two housing sections coaxial with the axis of rotation, each housing section comprising:
an internal circumferential channel configured to receive a ferromagnetic core and coaxial with the axis of rotation;
a ferromagnetic core mechanically and thermally coupled to the internal circumferential channel and having a toroidal yoke with teeth protruding in an axial direction relative to the axis of rotation and the teeth are equally spaced in a circumferential direction relative to the axis of rotation;
a printed circuit board (PCB) stator assembly mechanically and thermally coupled to the housing section, coaxial with the axis of rotation, and having windows through which the ferromagnetic core teeth protrude in an axial direction, wherein the number of windows is the same as the number of teeth;
an external circumferential channel; and the device further comprises:

an air gap between the ferromagnetic cores;

a rotor coaxial with the axis of rotation and axially positioned at a center of the air gap, the rotor comprising:
a rotor disk comprising a nonmagnetic material having rotor windows equally spaced apart in a circumferential direction, and a magnet is coupled to each rotor window; and
each magnet comprises magnet segments, wherein the magnet segments are oriented circumferentially and are mechanically bonded together and electrically insulated from each other; and
side surfaces of the rotor windows and side surfaces of respective magnets form an acute angle with narrow portions thereof adjacent an outer diameter of the rotor disk.

cooling plates coupled and sealed to the housing sections and facing the external circumferential channels, respectively, and each cooling plate comprises circumferential walls configured to direct circulation of a liquid coolant.

2. The device wherein the ferromagnetic cores comprise a soft ferromagnetic material.

3. The device wherein the ferromagnetic cores comprise a soft magnetic composite (SMC) material.

4. The device wherein each ferromagnetic core is segmented, and core split lines segmenting each ferromagnetic core are located along radial centerlines of the teeth.

5. The device wherein each ferromagnetic core is laminated and comprises a wound strip of soft ferromagnetic alloy.

6. The device wherein the ferromagnetic cores have recesses that are coupled to tabs fastened to the housing sections to prevent the ferromagnetic cores from detaching from the housing sections, respectively.

7. The device wherein each PCB stator assembly comprises PCB panels that are discrete and stacked together and aligned axially.

8. The device wherein pairs of PCB panels have terminals that are aligned and coupled to form a series connection therebetween.

9. The device wherein the PCB panels have terminals that are aligned and connected in parallel.

10. The device wherein each PCB stator assembly comprises PCB stator segments.

11. The device wherein the axial field rotary energy device has N electric phases, and a number of the PCB stator segments is a multiple of N.

12. The device wherein:

each housing section has grooved bands adjacent to each inner and outer side of the internal circumferential channel, the grooves in each grooved band are oriented in a radial direction, and each grooved band has a radial width A;
the PCB stator assembly has coils and each coil has end turns with a radial width B;
the end turns are radially aligned with the grooved bands, respectively; and
the radial width A is equal to or greater than the radial width B.

13. The device wherein each housing section further comprises a peripheral channel aligned with terminals of a respective PCB stator assembly, and the peripheral channel contains conductors for the respective PCB stator assembly.

14. The device wherein the ferromagnetic cores comprise a soft ferromagnetic material.

15. The device wherein the ferromagnetic cores comprise a soft magnetic composite (SMC) material.

16. The device wherein each ferromagnetic core is segmented, and core split lines segmenting the ferromagnetic cores are located along radial centerlines of the teeth.

17. The device wherein each ferromagnetic core is laminated and comprises a wound strip of soft ferromagnetic alloy.

18. The device wherein the ferromagnetic cores have recesses that are coupled to tabs fastened to the housing sections to prevent the ferromagnetic cores from detaching from the housing sections, respectively.

19. The device wherein each PCB stator assembly comprises PCB panels that are discrete and stacked together and aligned axially.

20. The device wherein pairs of the PCB panels have terminals that are aligned and connected in series.

21. The device wherein the PCB panels have terminals that are aligned and connected in parallel.

22. The device wherein the PCB stator assembly comprises PCB stator segments.

23. The device wherein the axial field rotary energy device has N electric phases, and a number PCB stator segments is a multiple of N.

24. The device wherein each rotor disk window is configured to receive a wedge that is fastened to the rotor and applies a radially oriented clamping force to a respective magnet.

### Rotors and Liquid Cooling

1. An axial field rotary energy device, comprising:

a housing having housing sections coaxially coupled along an axis of rotation, each housing section comprising:

a ferromagnetic core mechanically and thermally coupled to the housing section and comprising teeth;

a printed circuit board (PCB) stator assembly mechanically and thermally coupled to the housing section, coaxial with the axis, and comprising stator windows through which the teeth of the ferromagnetic core protrude, wherein a quantity of the stator windows equals a quantity of the teeth;

a chamber configured to receive and direct a flow of a liquid coolant;

a first lobe aligned and sealed with an adjacent first lobe on an adjacent housing section and, collectively, the first lobes form a manifold to distribute the liquid coolant to the housing sections; and

a second lobe aligned with an adjacent second lobe on the adjacent housing section and, collectively, the second lobes form a cavity containing conductors for electrical connections of the PCB stator assemblies; and the device further comprises:

an air gap defined between each facing pair of the ferromagnetic cores;

a rotor coaxial with the axis, comprising:

a rotor disk axially positioned in a center of each respective air gap, each rotor disk comprises an electrically non-conductive material with rotor windows that are equally spaced apart from each other in a circumferential direction, and a magnet is coupled to each rotor window;

each magnet comprises magnet segments, wherein the magnet segments are oriented circumferentially and are mechanically bonded together and electrically insulated from each other; and

covers coupled to outermost ones of the housing sections, respectively, each cover is configured to contain circulation of the liquid coolant.

2. The device wherein the ferromagnetic cores comprise a soft ferromagnetic material.

3. The device wherein the ferromagnetic cores comprise a soft magnetic composite (SMC) material.

4. The device wherein each ferromagnetic core comprises core segments, and each core segment has ends with respective core split lines, and each core split line is located at or adjacent to a respective radial centerline of a respective tooth of the core segment.

5. The device wherein each ferromagnetic core is laminated and comprises a wound strip of soft ferromagnetic alloy.

6. The device further comprising recesses that are complementary in the housing sections and the ferromagnetic cores, respectively, and tabs are located in the recesses to couple housing sections to the ferromagnetic cores to prevent the ferromagnetic cores from detaching from the housing sections, respectively.

7. The device wherein each PCB stator assembly comprises PCB panels that are discrete, stacked together and aligned axially.

8. The device wherein pairs of the PCB panels have terminals that are aligned and connected in series.

9. The device wherein the PCB panels have terminals that are aligned and connected in parallel.

10. The device wherein each PCB stator assembly comprises PCB stator segments that are coupled together.

11. The device wherein the device is configured to comprise N electric phases, and a quantity of the PCB stator segments is a multiple of N.

12. The device wherein each housing section further comprises an internal circumferential channel that is coaxial with the axis and a respective ferromagnetic core is mechanically and thermally coupled to the internal circumferential channel.

13. The device wherein the ferromagnetic core comprises a toroidal yoke and the teeth protrude in an axial direction relative to the axis.

14. The device wherein the teeth are equally spaced apart from each other in a circumferential direction relative to the axis.

15. The device wherein:

each housing section has grooved bands adjacent to inner and outer diameter sides of the internal circumferential channel wherein, relative to the axis, grooves in the grooved bands are oriented in a radial direction, and the grooved bands comprise a radial width A;

each PCB stator assembly has coils and each coil has end turns with a radial width B;

each PCB stator assembly is positioned in the housing section such that the end turns radially align with the grooved bands of the housing section, respectively; and

the radial width A is equal to or greater than the radial width B such that the grooved bands overlap the end turns, respectively.

16. The device wherein each housing section further comprises a peripheral channel that is radially outboard of the grooved bands adjacent the outer diameter side of the internal circumferential channel, the peripheral channel is aligned with terminals of a respective PCB stator assembly, and the peripheral channel comprises conductors for electrical connections with the terminals of the respective PCB stator assembly.

17. The device wherein each rotor window comprises a wedge that is coupled thereto to apply a radially-oriented clamping force to a respective magnet.

18. An axial field rotary energy device, comprising:

a housing having housing sections coaxially coupled along an axis of rotation, each housing section comprising:

a ferromagnetic core mechanically and thermally coupled to the housing section and comprising teeth;

a printed circuit board (PCB) stator assembly mechanically and thermally coupled to the housing section, coaxial with the axis, and comprises stator windows through which the teeth of the ferromagnetic core protrude, wherein a quantity of the stator windows equals a quantity of the teeth;

a chamber configured to receive and direct a flow of a liquid coolant;

a first lobe aligned and sealed with an adjacent first lobe on an adjacent housing section and, collectively, the first lobes distribute the liquid coolant to the housing sections; and

a second lobe aligned with an adjacent second lobe on the adjacent housing section and, collectively, the second lobes for a cavity containing electrical conductors for the PCB stator assemblies; and

an air gap formed between facing ones of the ferromagnetic cores; and the device further comprises:

a rotor coaxial with the axis, comprising:

a rotor disk axially positioned in a center of each air gap, each rotor disk has a flange comprising a continuously wound strip of a soft magnetic material, each rotor disk comprises magnets on both sides of the rotor disk;

each magnet comprises magnet segments that are oriented circumferentially, mechanically bonded together and electrically insulated from each other; and

covers coupled to outermost ones of the housing sections, respectively, each cover is configured to contain and direct circulation of the liquid coolant.

19. The device wherein the ferromagnetic cores comprise a soft ferromagnetic material.

20. The device wherein the ferromagnetic cores comprise a soft magnetic composite (SMC) material.

21. The device wherein each ferromagnetic core comprises core segments, and each core segment has ends with core split lines, and each core split line is located at or adjacent to a radial centerline of a tooth of the core segment, respectively.

22. The device wherein each ferromagnetic core is laminated and comprises a wound strip of soft ferromagnetic alloy.

23. The device further comprising recesses that are complementary in the housing sections and the ferromagnetic cores, and a tab is located in each complementary pair of the recesses to couple the housing sections to ferromagnetic cores to prevent the ferromagnetic cores from detaching from the housing sections, respectively.

24. The device wherein each PCB stator assembly comprises PCB panels that are discrete, stacked together and aligned axially.

25. The device wherein pairs of the PCB panels have terminals that are aligned and connected in series.

26. The device wherein PCB panels have terminals that are aligned and connected in parallel.

27. The device wherein each PCB stator assembly comprises PCB stator segments that are coupled together.

28. The device wherein the device is configured to comprise N electric phases, and a quantity of the PCB stator segments is a multiple of N.

29. The device wherein each housing section further comprises an internal circumferential channel that is coaxial with the axis, and a respective ferromagnetic core is mechanically and thermally coupled to the internal circumferential channel.

30. The device wherein each ferromagnetic core comprises a toroidal yoke and the teeth protrude in an axial direction relative to the axis.

31. The device wherein the teeth are equally spaced apart from each other in a circumferential direction relative to the axis.

32. The device wherein:

each housing section comprises grooved bands adjacent to inner and outer diameter sides of a respective internal circumferential channel, grooves in the grooved bands are oriented in a radial direction, and the grooved bands comprise a radial width A;

each PCB stator assembly has coils and each coil has end turns with a radial width B;

the end turns radially align with respective grooved bands of the respective housing section; and

the radial width A is equal to or greater than the radial width B, such that the grooved bands overlap the end turns, respectively.

33. The device wherein each housing section further comprises a peripheral channel that is radially outboard of respective grooved bands adjacent the outer diameter side of the respective internal circumferential channel, the peripheral channel is radially aligned with terminals of a respective PCB stator assembly, and the peripheral channel comprises conductors for electrical connections with the terminals of the respective PCB stator assembly.

34. The device the rotor disk comprises a flange with pockets for the magnets.

35. The device wherein the chamber of each housing section comprises an external circumferential channel with circumferential walls.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined by the claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

What is claimed is:

1. An axial field rotary energy device, comprising:
a housing having housing sections coaxially coupled along an axis of rotation, each housing section comprising:
a ferromagnetic core mechanically and thermally coupled to the housing section and comprising teeth;
a printed circuit board (PCB) stator assembly mechanically and thermally coupled to the housing section, coaxial with the axis, and comprising stator windows through which the teeth of the ferromagnetic core protrude, wherein a quantity of the stator windows equals a quantity of the teeth;
a chamber configured to receive and direct a flow of a liquid coolant;
a first lobe aligned and sealed with an adjacent first lobe on an adjacent housing section and, collectively, the first lobes form a manifold to distribute the liquid coolant to the housing sections; and
a second lobe aligned with an adjacent second lobe on the adjacent housing section and, collectively, the second lobes form a cavity containing conductors for electrical connections of the PCB stator assemblies; and the device further comprises:
an air gap defined between each facing pair of the ferromagnetic cores;
a rotor coaxial with the axis, comprising:
a rotor disk axially positioned in a center of each respective air gap, each rotor disk comprises an electrically non-conductive material with rotor windows that are equally spaced apart from each other in a circumferential direction, and a magnet is coupled to each rotor window;
each magnet comprises magnet segments, wherein the magnet segments are oriented circumferentially and are mechanically bonded together and electrically insulated from each other; and
covers coupled to outermost ones of the housing sections, respectively, each cover is configured to contain circulation of the liquid coolant.

2. The device of claim 1, wherein the ferromagnetic cores comprise a soft ferromagnetic material.

3. The device of claim 2, wherein the ferromagnetic cores comprise a soft magnetic composite (SMC) material.

4. The device of claim 3, wherein each ferromagnetic core comprises core segments, and each core segment has ends with respective core split lines, and each core split line is located at or adjacent to a respective radial centerline of a respective tooth of the core segment.

5. The device of claim 2, wherein each ferromagnetic core is laminated and comprises a wound strip of soft ferromagnetic alloy.

6. The device of claim 1, further comprising recesses that are complementary in the housing sections and the ferromagnetic cores, respectively, and tabs are located in the recesses to couple housing sections to the ferromagnetic cores to prevent the ferromagnetic cores from detaching from the housing sections, respectively.

7. The device of claim 1, wherein each PCB stator assembly comprises PCB panels that are discrete, stacked together and aligned axially.

8. The device of claim 7, wherein pairs of the PCB panels have terminals that are aligned and connected in series.

9. The device of claim 7, wherein the PCB panels have terminals that are aligned and connected in parallel.

10. The device of claim 7, wherein each PCB stator assembly comprises PCB stator segments that are coupled together.

11. The device of claim 10, wherein the device is configured to comprise N electric phases, and a quantity of the PCB stator segments is a multiple of N.

12. The device of claim 1, wherein each housing section further comprises an internal circumferential channel that is coaxial with the axis and a respective ferromagnetic core is mechanically and thermally coupled to the internal circumferential channel.

13. The device of claim 12, wherein the ferromagnetic core comprises a toroidal yoke and the teeth protrude in an axial direction relative to the axis.

14. The device of claim 13, wherein the teeth are equally spaced apart from each other in a circumferential direction relative to the axis.

15. The device of claim 12, wherein:
each housing section has grooved bands adjacent to inner and outer diameter sides of the internal circumferential channel wherein, relative to the axis, grooves in the grooved bands are oriented in a radial direction, and the grooved bands comprise a radial width A;
each PCB stator assembly has coils and each coil has end turns with a radial width B;
each PCB stator assembly is positioned in the housing section such that the end turns radially align with the grooved bands of the housing section, respectively; and
the radial width A is equal to or greater than the radial width B such that the grooved bands overlap the end turns, respectively.

16. The device of claim 15, wherein each housing section further comprises a peripheral channel that is radially outboard of the grooved bands adjacent the outer diameter side of the internal circumferential channel, the peripheral channel is aligned with terminals of a respective PCB stator assembly, and the peripheral channel comprises conductors for electrical connections with the terminals of the respective PCB stator assembly.

17. The device of claim 1, wherein each rotor window comprises a wedge that is coupled thereto to apply a radially-oriented clamping force to a respective magnet.

18. An axial field rotary energy device, comprising:
a housing having housing sections coaxially coupled along an axis of rotation, each housing section comprising:
a ferromagnetic core mechanically and thermally coupled to the housing section and comprising teeth;
a printed circuit board (PCB) stator assembly mechanically and thermally coupled to the housing section, coaxial with the axis, and comprises stator windows through which the teeth of the ferromagnetic core protrude, wherein a quantity of the stator windows equals a quantity of the teeth;
a chamber configured to receive and direct a flow of a liquid coolant;
a first lobe aligned and sealed with an adjacent first lobe on an adjacent housing section and, collectively, the first lobes distribute the liquid coolant to the housing sections; and
a second lobe aligned with an adjacent second lobe on the adjacent housing section and, collectively, the second lobes for a cavity containing electrical conductors for the PCB stator assemblies; and
an air gap formed between facing ones of the ferromagnetic cores; and the device further comprises:
a rotor coaxial with the axis, comprising:
a rotor disk axially positioned in a center of each air gap, each rotor disk has a flange comprising a continuously wound strip of a soft magnetic material, each rotor disk comprises magnets on both sides of the rotor disk;
each magnet comprises magnet segments that are oriented circumferentially, mechanically bonded together and electrically insulated from each other; and
covers coupled to outermost ones of the housing sections, respectively, each cover is configured to contain and direct circulation of the liquid coolant.

19. The device of claim 18, wherein the ferromagnetic cores comprise a soft ferromagnetic material.

20. The device of claim 19, wherein the ferromagnetic cores comprise a soft magnetic composite (SMC) material.

21. The device of claim 20, wherein each ferromagnetic core comprises core segments, and each core segment has ends with core split lines, and each core split line is located at or adjacent to a radial centerline of a tooth of the core segment, respectively.

22. The device of claim 19, wherein each ferromagnetic core is laminated and comprises a wound strip of soft ferromagnetic alloy.

23. The device of claim 18, further comprising recesses that are complementary in the housing sections and the ferromagnetic cores, and a tab is located in each complementary pair of the recesses to couple the housing sections to ferromagnetic cores to prevent the ferromagnetic cores from detaching from the housing sections, respectively.

24. The device of claim 18, wherein each PCB stator assembly comprises PCB panels that are discrete, stacked together and aligned axially.

25. The device of claim 24, wherein pairs of the PCB panels have terminals that are aligned and connected in series.

26. The device of claim 24, wherein PCB panels have terminals that are aligned and connected in parallel.

27. The device of claim 24, wherein each PCB stator assembly comprises PCB stator segments that are coupled together.

28. The device of claim 27, wherein the device is configured to comprise N electric phases, and a quantity of the PCB stator segments is a multiple of N.

29. The device of claim 18, wherein each housing section further comprises an internal circumferential channel that is coaxial with the axis, and a respective ferromagnetic core is mechanically and thermally coupled to the internal circumferential channel.

30. The device of claim 29, wherein each ferromagnetic core comprises a toroidal yoke and the teeth protrude in an axial direction relative to the axis.

31. The device of claim 30, wherein the teeth are equally spaced apart from each other in a circumferential direction relative to the axis.

32. The device of claim 29, wherein:
each housing section comprises grooved bands adjacent to inner and outer diameter sides of a respective internal circumferential channel, grooves in the grooved bands are oriented in a radial direction, and the grooved bands comprise a radial width A;
each PCB stator assembly has coils and each coil has end turns with a radial width B;
the end turns radially align with respective grooved bands of the respective housing section; and
the radial width A is equal to or greater than the radial width B, such that the grooved bands overlap the end turns, respectively.

33. The device of claim 32, wherein each housing section further comprises a peripheral channel that is radially outboard of respective grooved bands adjacent the outer diameter side of the respective internal circumferential channel, the peripheral channel is radially aligned with terminals of a respective PCB stator assembly, and the peripheral channel comprises conductors for electrical connections with the terminals of the respective PCB stator assembly.

34. The device of claim 18, the rotor disk comprises a flange with pockets for the magnets.

35. The device of claim 18, wherein the chamber of each housing section comprises an external circumferential channel with circumferential walls.
